(19) United States
(12) Patent Application Publication
(10) Pub. No.: US 2021/0375515 A1
(43) Pub. Date: Dec. 2, 2021

(54) RARE EARTH MAGNET AND PRODUCTION METHOD THEREOF

(71) Applicant: TOYOTA JIDOSHA KABUSHIKI KAISHA, Toyota-shi (JP)

(72) Inventors: Noritsugu SAKUMA, Mishima-shi (JP); Tetsuya SHOJI, Susono-shi (JP); Yukio TAKADA, Nagakute-shi (JP)

(73) Assignee: TOYOTA JIDOSHA KABUSHIKI KAISHA, Toyota-shi (JP)

(21) Appl. No.: 17/219,995

(22) Filed: Apr. 1, 2021

(30) Foreign Application Priority Data
Jun. 1, 2020 (JP) 2020-095349

(51) Int. Cl. H01F 1/057; H01F 41/02; B22F 9/04; C22C 38/00; C22C 38/10; C22C 38/16; C22C 38/06

(52) U.S. Cl. CPC H01F 1/0577; H01F 41/0293; B22F 9/04; C22C 38/005; C22C 38/10; C22C 2202/02; C22C 38/06; C22C 38/002; B22F 2009/048; B22F 2301/355; C22C 38/16

(57) ABSTRACT

To provide an R—Fe—B-based rare earth magnet excellent in the squareness and magnetic properties at high temperatures, and a production method thereof.

The present disclosure provides a rare earth magnet including a main phase 10 and a grain boundary phase 20 present. The overall composition of the rare earth magnet of the present disclosure is represented, in terms of molar ratio, by the formula: (R¹₍₁₋ₓ₎Laₓ)_{y}(Fe_{(1-z)}Co_{z})_{(100-y-w-v)}B_{w}M¹ᵥ, wherein R¹ is one or more predetermined rare earth elements, and M¹ is one or more predetermined elements, and wherein 0.02≤x≤0.1, 12.0≤y≤20.0, 0.1≤z≤0.3, 5.0≤w≤20.0, and 0≤v≤2.0. The main phase 10 has an R₂Fe₁₄B-type crystal structure, the average particle diameter of the main phase 10 is from 1 to 10 μm, and the volume ratio of a phase having an RFe₂-type crystal structure in the grain boundary phase 20 is 0.60 or less relative to the grain boundary phase 20.

### TECHNICAL FIELD

The present disclosure relates to a rare earth magnet and a production method thereof. More specifically, the present disclosure relates to an R—Fe—B-based rare earth magnet, wherein R is one or more rare earth elements, and a production method thereof.

### BACKGROUND ART

The R—Fe—B-based rare earth magnet has a main phase and a grain boundary phase present around the main phase. The main phase is a magnetic phase having an R₂Fe₁₄B-type crystal structure. This main phase enables obtaining high residual magnetization. Accordingly, the R—Fe—B-based rare earth magnet is often used for motors.

In the case where a permanent magnet such as the R—Fe—B-based rare earth magnet is used for motors, the permanent magnet is disposed under a periodically changing external magnetic field environment, and therefore the permanent magnet may be demagnetized due to an increase in the external magnetic field. In using a permanent magnet for motors, it is required to cause as little demagnetization as possible by an increase in the external magnetic field. A demagnetization curve shows the degree of demagnetization by an increase in the external magnetic field, and the demagnetization curve satisfying the requirement above has a square shape. Consequently, satisfying the above-described requirement is referred to as being excellent in squareness.

Since a motor generates heat during its operation, the permanent magnet used for motors is required to have high residual magnetization at high temperatures. In the present description, regarding the magnetic properties, the high temperature refers to a temperature in the range from 130 to 200° C., particularly from 140 to 180° C.

As R of the R—Fe—B-base rare earth magnet, Nd has been mainly selected, but the rapid spread of electric vehicles poses a concern for a soaring price of Nd. For this reason, use of inexpensive light rare earth elements is also being studied. For example, Patent Literature 1 discloses an R—Fe—B-based rare eth magnet where light rare earth elements Ce and La are selected as R of the R—Fe—B-based rare earth magnet.

### RELATED ART

### Patent Document

[Patent Document 1] Japanese Unexamined Patent Publication No. S61-159708

### SUMMARY OF INVENTION

### Technical Problem

When one or more light rare earth elements are simply selected as R as in the R—Fe—B-based rare earth magnet disclosed in Patent Literature 1, the magnetic properties are reduced. In addition, it has been conventionally known that containing Co is effective in enhancing the magnetic properties at high temperatures, particularly, the residual magnetization at high temperatures. However, the squareness is deteriorated by the containing Co.

The present disclosure has been made to solve the problems above. An object of the present disclosure is to provide an R—Fe—B-based rare earth magnet excellent in the squareness and magnetic properties at high temperatures, particularly, the residual magnetization at high temperatures, and a production method thereof.

### Solution to Problem

The present inventors have made many intensive studies to attain the object above and have accomplished the rare earth magnet of the present disclosure and the production method thereof. The rare earth magnet of the present disclosure and the production method thereof include the following aspects.

<1> A rare earth magnet including a main phase and a grain boundary phase present around the main phase, wherein

the overall composition is represented, in terms of molar ratio, by the formula: (R¹₍₁₋ₓ₎Laₓ)_{y}(Fe_{(1-z)}Co_{z})_{(100-y-w-v)}B_{w}M¹ᵥ, wherein R¹ is one or more elements selected from the group consisting of Nd, Pr, Gd, Tb, Dy, and Ho, and M¹ is one or more elements selected from the group consisting of Ga, Al, Cu, Au, Ag, Zn, In, and Mn, and unavoidable impurity elements, and wherein

0.02≤x≤0.1,

12.0≤y≤20.0,

0.1≤z≤0.3,

5.0≤w≤20.0, and

0≤v≤2.0,

the main phase has an R₂Fe₁₄B-type crystal structure, wherein R is one or more rare earth elements,

the average particle diameter of the main phase is from 1 to 10 μm, and

the volume ratio of a phase having an RFe₂-type crystal structure in the grain boundary phase is 0.60 or less relative to the grain boundary phase.

<2> A rare earth magnet including a main phase and a grain boundary phase present around the main phase, wherein

the overall composition is represented, in terms of molar ratio, by the formula: (R¹₍₁₋ₓ₎Laₓ)_{y}(Fe_{(1-z)}Co_{z})_{(100-y-w-v)}B_{w}M¹ᵥ.(R²₍₁₋ₛ₎M²ₛ)ₜ, wherein each of R¹ and R² is one or more elements selected from the group consisting of Nd, Pr, Gd, Tb, Dy, and Ho, M¹ is one or more elements selected from the group consisting of Ga, Al, Cu, Au, Ag, Zn, In, and Mn, and unavoidable impurity elements, and M² is one or more metal elements, which are alloyed with R², other than rare earth elements, and unavoidable impurity elements, and wherein

0.02≤x≤0.1,

12.0≤y≤20.0,

0.1≤z≤0.3,

5.0≤w≤20.0,

0≤v≤2.0,

0.05≤s≤0.40, and

0.1≤t≤10.0

the main phase has an R₂Fe₁₄B-type crystal structure, wherein R is one or more rare earth elements,

the average particle diameter of the main phase is from 1 to 10 μm, and

the volume ratio of a phase having an RFe₂-type crystal structure in the grain boundary phase is 0.60 or less relative to the grain boundary phase.

<3> The rare earth magnet according to item <2>, wherein t satisfies 0.5≤t≤2.0.

<4> The rare earth magnet according to item <2> or <3>, wherein R² is Tb and M² is Cu and unavoidable impurity elements.

<5> The rare earth magnet according to any one of items <1> to <4>, wherein the microstructural parameter α represented by the formula: H_{c}=α·Hₐ−N_{eff}·Mₛ, wherein H_{c} is the coercivity, Hₐ is the anisotropic magnetic field, Mₛ is the saturation magnetization, and N_{eff} is the self-demagnetizing field coefficient, is from 0.30 to 0.70.

<6> The rare earth magnet according to any one of items <1> to <5>, wherein R¹ is one or more elements selected from the group consisting of Nd and Pr and M¹ is one or more elements selected from Ga, Al and Cu, and unavoidable impurity elements.

<7> A method for producing the rare earth magnet according to item <1>, including:

preparing a molten alloy having a composition represented, in terms of molar ratio, by the formula: (R¹₍₁₋ₓ₎Laₓ)_{y}(Fe_{(1-z)}Co_{z})_{(100-y-w-v)}B_{w}M¹ᵥ, wherein R¹ is one or more elements selected from the group consisting of Nd, Pr, Gd, Tb, Dy, and Ho, and M¹ is one or more elements selected from the group consisting of Ga, Al, Cu, Au, Ag, Zn, In, and Mn, and unavoidable impurity elements, and wherein

0.02≤x≤0.1,

12.0≤y≤20.0,

0.1≤z≤0.3,

5.0≤w≤20.0, and

0≤v≤2.0,

cooling the molten alloy at a rate of 1 to 10⁴° C./sec to obtain a magnetic ribbon or a thin magnetic strip,

pulverizing the magnetic ribbon or the thin magnetic strip to obtain a magnetic powder, and

sintering the magnetic powder at 900 to 1,100° C. to obtain a sintered body.

<8> The production method of a rare earth magnet according to item <7>, wherein the sintered body is held at 850 to 1,000° C. over 50 to 300 minutes and then cooled to 450 to 700° C. at a rate of 0.1 to 5.0° C./min.

<9> The production method of a rare earth magnet according to item <7> or <8>, further including:

preparing a modifier having a composition represented, in terms of molar ratio, by the formula: R²₍₁₋ₛ₎M²ₛ, wherein R² is one or more elements selected from the group consisting of Nd, Pr, Gd, Tb, Dy, and Ho, and M² is one or more metal elements, which are alloyed with R², other than rare earth elements, and unavoidable impurity elements, and wherein 0.05≤s≤0.40, and

diffusing and penetrating the modifier into the sintered body.

<10> The production method of a rare earth magnet according to item <9>, wherein the modifier is brought into contact with the sintered body to obtain a contact body and the contact body is heated at 900 to 1,000° C., held at 900 to 1,000° C. over 50 to 300 minutes and then cooled to 450 to 700° C. at a rate of 0.1 to 5.0° C./min to diffuse and penetrate the modifier into the sintered body.

<11> The production method of a rare earth magnet according to item <9> or <10>, wherein the sintered body is held at 850 to 1,000° C. over 50 to 300 minutes at least either before or after the diffusion and penetration of the modifier and then cooled to 450 to 700° C. at a rate of 0.1 to 5.0° C./min.

<12> The production method of a rare earth magnet according to item <7>, including:

preparing a modifier powder having a composition represented, in terms of molar ratio, by the formula: R²₍₁₋ₛ₎M²ₛ, wherein R² is one or more elements selected from the group consisting of Nd, Pr, Gd, Tb, Dy, and Ho, and M² is one or more metal elements, which are alloyed with R², other than rare earth elements, and unavoidable impurity elements, and wherein 0.05≤s≤0.40,

mixing the magnetic powder and the modifier powder to obtain a mixed powder, and

sintering the mixed powder at 900 to 1,100° C. to obtain a sintered body.

<13> The production method of a rare earth magnet according to item <12>, wherein the sintered body obtained by sintering the mixed powder is held at 850 to 1,000° C. over 50 to 300 minutes and then cooled to 450 to 700° C. at a rate of 0.1 to 5.0° C./min.

<14> The production method of a rare earth magnet according to any one of items <9> to <13>, wherein R² is Tb and M² is Cu and unavoidable impurity elements.

<15> The production method of a rare earth magnet according to any one of items <7> to <14>, wherein R¹ is one or more elements selected from the group consisting of Nd and Pr and M¹ is one or more elements selected from Ga, Al and Cu, and unavoidable impurity elements.

### Advantageous Effects of Invention

According to the present disclosure, an R—Fe—B-based rare earth magnet where generation of a phase having an RFe₂-type crystal structure that impairs squareness is suppressed by selecting La as part of R and high-temperature magnetic properties, particularly, high-temperature magnetization, are enhanced by containing Co, and a production method thereof can be provided.

Furthermore, according to the present disclosure, an R—Fe—B-based rare earth magnet where the coercivity at high temperatures is enhanced by slowly cooling the sintered body so as to make the contact surface between the main phase and the grain boundary phase be a facet interface, and a production method thereof can be provided. Incidentally, the phrase “the contact surface between the main phase and the grain boundary phase is a facet interface” indicates that the microstructural parameter α is from 0.30 to 0.70.

### BRIEF DESCRIPTION OF DRAWINGS

FIG. 1A is an explanatory diagram schematically illustrating the microstructure of the rare earth magnet of the present disclosure.

FIG. 1B is an explanatory diagram enlarging the portion shown by a dashed line in FIG. 1A.

FIG. 2 is an explanatory diagram schematically illustrating the cooling apparatus used for a strip casting method.

FIG. 3 is a graph illustrating a demagnetization curve of the sample of Example 2.

FIG. 4 is a graph illustrating a demagnetization curve of the sample of Comparative Example 3.

FIG. 5A is an SEM image illustrating the SEM observation results of the sample of Example 2.

FIG. 5B is a backscattered electron image illustrating the SEM observation results of the sample of Example 2.

FIG. 5C is a graph illustrating the results of SEM-EDX analysis (line analysis) of the part shown by a white line in FIG. 5A and FIG. 5B.

FIG. 6A is an SEM image illustrating the SEM observation results of the sample of Comparative Example 3.

FIG. 6B is a backscattered electron image illustrating the SEM observation results of the sample of Comparative Example 3.

FIG. 6C is a graph illustrating the results of SEM-EDX analysis (line analysis) of the part shown by a white line in FIG. 6A and FIG. 6B.

FIG. 7 is a TEM image illustrating the results of microstructure observation of a vicinity of the contact surface between the main phase and the grain boundary phase regarding the sample of Example 2.

FIG. 8A is a diagram schematically illustrating the microstructure of the conventional rare earth magnet.

FIG. 8B is an explanatory diagram enlarging the portion shown by a dashed line in FIG. 8A.

### DESCRIPTION OF EMBODIMENTS

The embodiments of the rare earth magnet of the present disclosure and the production method thereof are described in detail below. Incidentally, the embodiments described below should not be construed to limit the rare earth magnet of the present disclosure and the production method thereof.

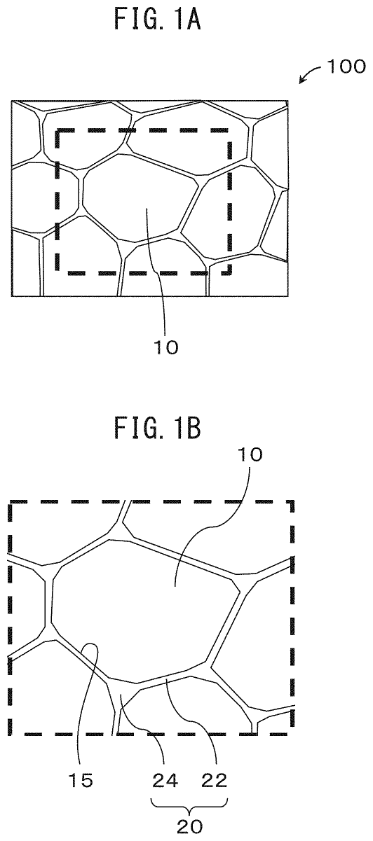

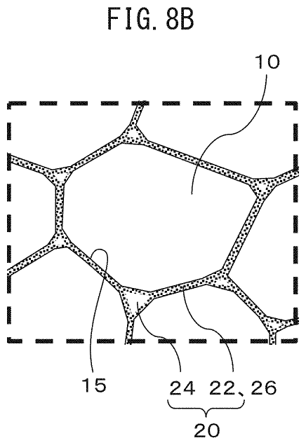

The knowledge acquired by the present inventors regarding the reason why the coexistence of La and Co is effective in enhancing the squareness and the magnetic properties at high temperatures, particularly, the residual magnetization at high temperatures, is described using the drawings. FIG. 1A is an explanatory diagram schematically illustrating the microstructure of the rare earth magnet of the present disclosure. FIG. 1B is an explanatory diagram enlarging the portion shown by a dashed line in FIG. 1A. FIG. 8A is a diagram schematically illustrating the microstructure of the conventional rare earth magnet. FIG. 8B is an explanatory diagram enlarging the portion shown by a dashed line in FIG. 8A.

In an R—Fe—B-based rare earth magnet, a phase having an R₂Fe₁₄B-type crystal structure can be stably obtained by solidifying a molten alloy containing a larger amount of R than in the theoretical composition of R₂Fe₁₄B (R is 11.8 mol %, Fe is 82.3 mol %, and B is 5.9 mol %). In the following description, the molten alloy containing a larger amount of R than in the theoretical composition of R₂Fe₁₄B is sometimes referred to as “R-rich molten alloy”, and a phase having an R₂Fe₁₄B-type crystal structure is sometimes referred to as “R₂Fe₁₄B phase”.

When an R-rich molten alloy is solidified, as illustrated in FIG. 1 and FIG. 8, a microstructure including a main phase 10 and a grain boundary phase 20 present around the main phase 10 is obtained. The grain boundary phase 20 has an adjacent part 22 in which two main phases 10 are adjacent to each other, and a triple point 24 surrounded by three main phases 10. In the conventional rare earth magnet 200, many phases 26 having an RFe₂-type crystal structure are present in the adjacent part 22 of the grain boundary phase 20. The phase having an RFe₂-type crystal structure is a ferromagnetic phase and when many phases having an RFe₂-type crystal structure are present in the grain boundary phase 20, the squareness is reduced.

The R—Fe—B-based rare earth magnet includes a sintered magnet obtained by sintering a magnetic powder, with the main phase having a particle diameter of 1 to 10 μm, at a high temperature of 900 to 1,100° C. or more, and a hot-worked magnet obtained by hot pressing a magnetic powder, with the main phase being nanocrystallized, at a low temperature of 550 to 750° C. The magnetic powder with the main phase having a particle diameter of 1 to 10 μm is obtained by quenching a molten alloy having a composition of the R—Fe—B-based rare earth magnet by use of a strip casting method, etc. The magnetic powder with the main phase being nanocrystallized is obtained by super quenching a molten alloy having a composition of the R—Fe—B-based rare earth magnet by use of a liquid quenching method, etc.

A phase 26 having an RFe₂-type crystal structure illustrated in FIG. 8B is readily generated at the time of obtaining a magnetic powder with the main phase having a particle diameter of 1 to 10 μm. Therefore, in the conventional R—Fe—B-based rare earth magnet, particularly, in a sintered magnet, a phase 26 having an RFe₂-type crystal structure is likely to be present.

When part of Fe of the R—Fe—B-based rare earth magnet is replaced by Co, the Curie point increases, and therefore the magnetic properties, particularly, the residual magnetization, is enhanced. On the other hand, when part of Fe of the R—Fe—B-based rare earth magnet is replaced by Co, a phase having an RFe₂-type crystal structure is readily generated. However, even when part of Fe of the R—Fe—B-based rare earth magnet is replaced by Co, generation of a phase having an RFe₂-type crystal structure can be suppressed by selecting La as part of R. Then, suppression of the generation of a phase having an RFe₂-type crystal structure allows the R—Fe—B-based rare earth magnet of the present disclosure to have excellent squareness. More specifically, as illustrated in FIG. 1A and FIG. 1B, in the rare earth magnet 100 of the present disclosure, a phase 26 having an RFe₂-type crystal structure is not present in the grain boundary phase 20, and even if it is present, the amount thereof is very small. Consequently, the rare earth magnet 100 of the present disclosure illustrated in FIG. 1A and FIG. 1B has excellent squareness. In addition, a phase 26 having an RFe₂-type crystal structure is likely to trigger the magnetization reversal, and therefore, when a phase 26 having an RFe₂-type crystal structure is not present or even if it is present, the amount thereof is very small, this contributes to an enhancement of coercivity.

As disclosed in Patent Literature 1, in the case of selecting a light rare earth element as R, Ce has heretofore been commonly selected. However, since Ce promotes generation of a phase having an RFe₂-type crystal structure, in the rare earth magnet of the present disclosure, La is selected as the light rare earth element, other than a very small amount of Ce contained as an unavoidable impurity element.

Furthermore, the contact surface 15 between the main phase 10 and the grain boundary phase 20 is a facet interface, and the coercivity at high temperatures of the rare earth magnet 100 of the present disclosure is thereby enhanced. Such a facet interface is obtained by slowly cooling a sintered body of the magnetic powder. Whether the contact surface 15 between the main phase 10 and the grain boundary phase 20 is a facet interface or not can be determined by the microstructure parameter α. The microstructure parameter is described later.

The configuration requirements of the rare earth magnet of the present disclosure based on these knowledges and the production method thereof are described below.

### <<Rare Earth Magnet>>

First, the configuration requirements of the rare earth magnet of the present disclosure are described.

As illustrated in FIG. 1A, the rare earth magnet 100 of the present disclosure has a main phase 10 and a grain boundary phase 20. In the following, the overall composition, main phase 10 and grain boundary phase 20 of the rare earth magnet 100 of the present disclosure are described.

### <Overall Composition>

The overall composition of the rare earth magnet 100 of the present disclosure is described. The overall composition of the rare earth magnet 100 of the present disclosure means a combined composition of all main phases 10 and grain boundary phases 20.

The overall composition of the rare earth magnet of the present disclosure is, in terms of molar ratio, represented by the formula: (R¹₍₁₋ₓ₎Laₓ)_{y}(Fe_{(1-z)}Co_{z})_{(100-y-w-v)}B_{w}M¹ᵥ, or the formula: (R¹₍₁₋ₓ₎Laₓ)_{y}(Fe_{(1-z)}Co_{z})_{(100-y-w-v)}B_{w}M¹ᵥ.(R²₍₁₋ₛ₎M²ₛ)ₜ. The formula: (R¹₍₁₋ₓ₎Laₓ)_{y}(Fe_{(1-z)}Co_{z})_{(100-y-w-v)}B_{w}M¹ᵥ represents an overall composition when a modifier is not diffused and penetrated. The formula: (R¹₍₁₋ₓ₎Laₓ)_{y}(Fe_{(1-z)}Co_{z})_{(100-y-w-v)}B_{w}M¹ᵥ.(R²₍₁₋ₛ₎M²ₛ)ₜ represents an overall composition when a modifier is diffused and penetrated. In the formula, the first half (R¹₍₁₋ₓ₎Laₓ)_{y}(Fe_{(1-z)}Co_{z})_{(100-y-w-v)}B_{w}M¹ᵥ represents a composition derived from a sintered body (rare earth magnet precursor) before diffusing and penetrating a modifier, and the last half (R²₍₁₋ₛ₎M²ₛ)ₜ represents a composition derived from a modifier.

In the case of diffusing and penetrating a modifier, assuming 100 parts by mol of a sintered body is a rare earth magnet precursor, t parts by mol of a modifier is diffused and penetrated into the inside of the precursor, and (100+t) parts by mol of the rare earth magnet of the present disclosure is thereby obtained.

In the formula representing the rare earth magnet of the present disclosure, the total of R¹ and La is y parts by mol, the total of Fe and Co is (100−y−w−v) parts by mol, B is w parts by mol, and M¹ is v parts by mol. Accordingly, the total of these is y parts by mol+(100−y−w−v) parts by mol+w parts by mol+v parts by mol=100 parts by mol. The total of R² and M² is t parts by mol. When t is 0, it may be considered that the modifier is not diffused and penetrated into the rare earth magnet precursor.

In the formulae above, R¹₍₁₋ₓ₎Laₓ means that, in terms of molar ratio, (1−x)R¹ and xLa are present relative to the total of R¹ and La. Similarly, in the formulae above, Fe_{(1-z)}Co_{z} means that, in terms of molar ratio, (1−z)Fe and zCo are present relative to the total of Fe and Co. In addition, similarly, in the formulae above, R²₍₁₋ₛ₎M²ₛ means that, in terms of molar ratio, (1−s)R² and sM² are present relative to the total of R² and M².

In the formulae above, each of R¹ and R² is one or more elements selected from the group consisting of Nd, Pr, Gd, Tb, Dy, and Ho. Nd is neodymium, Pr is praseodymium, Gd is gadolinium, Tb is terbium, Dy is dysprosium, and Ho is holmium. Fe is iron, Co is cobalt, and B is boron. M¹ is one or more elements selected from the group consisting of Ga, Al, Cu, Au, Ag, Zn, In, and Mn, and unavoidable impurity elements. Ga is gallium, Al is aluminum, Cu is copper, Au is gold, Ag is silver, Zn is zinc, In is indium, and Mn is manganese. M² is one or more metal elements, which are alloyed with R², other than rare earth elements, and unavoidable impurity elements.

In the present description, unless otherwise indicated, the rare earth elements are 17 elements of Sc, Y, La, Ce, Pr, Nd, Pm, Sm, Eu, Gd, Tb, Dy, Ho, Er, Tm, Yb, and Lu. Particularly, unless otherwise indicated, Sc, Y, La, and Ce are light rare earth elements. In addition, unless otherwise indicated, Pr, Nd, Pm, Sm, and Eu are medium rare earth elements. Furthermore, unless otherwise indicated, Gd, Tb, Dy, Ho, Er, Tm, Yb, and Lu are heavy rare earth elements. Incidentally, in general, the rarity of the heavy rare earth element is high, and the rarity of the light rare earth element is low. The rarity of the medium rare earth element is between the heavy rare earth element and the light rare earth element. Note that Sc is scandium, Y is yttrium, La is lanthanum, Ce is cerium, Pr is praseodymium, Nd is neodymium, Pm is promethium, Sm is samarium, Eu is europium, Gd is gadolinium, Tb is terbium, Dy is dysprosium, Ho is holmium, Er is erbium, Tm is thulium, Yb is ytterbium, and Lu is lutetium.

The constituent elements of the rare earth magnet of the present disclosure represented by the formula above are described below.

### <R¹>

R¹ is an essential component for the rare earth magnet of the present disclosure. As described above, R¹ is one or more elements selected from the group consisting of Nd, Pr, Gd, Tb, Dy, and Ho. R¹ is an element constituting the main phase (a phase having an R₂Fe₁₄B-type crystal structure (hereinafter, sometimes referred to as “R₂Fe₁₄B phase”)). In view of the balance among residual magnetization, coercivity and cost, R¹ is preferably one or more elements selected from the group consisting of Nd and Pr. In the case of letting Nd and Pr be present together as R¹, didymium may be used.

### <La>

La is an essential component for the rare earth magnet of the present disclosure. La is an element constituting the R₂Fe₁₄B phase together with R¹. The rare earth magnet of the present disclosure contains both La and Co, and generation of a phase having an RFe₂-type crystal structure is thereby suppressed, as a result, the squareness of the rare earth magnet of the present disclosure is enhanced. Because, although not bound by theory, the atomic diameter of La is large compared with other rare earth elements, and this makes generation of a phase having an RFe₂-type crystal structure difficult.

When a modifier containing heavy rare earth elements, particularly, Tb and Dy, is diffused and penetrated, the effect of magnetically separating main phases from one another is large, but, on the other hand, a heavy rare earth element and Co diffused and penetrated into the grain boundary phase are likely to generate a phase having an RFe₂-type crystal structure. However, generation of a phase having an RFe₂-type crystal structure can be advantageously suppressed by containing La.

### <Molar Ratio of R¹ and La>

In the R—Fe—B-based rare earth magnet, it is difficult for La alone as R to generate an R₂Fe₁₄B phase with Fe and B. However, when La is selected as part of R, an R₂Fe₁₄B phase can be generated. In addition, when part of Fe is replaced by Co, generation of a phase having an RFe₂-type crystal structure can be suppressed due to La, as a result, the squareness can be enhanced.

When x is 0.02 or more, suppression of the generation of a phase having an RFe₂-type crystal structure is substantially recognized. From the viewpoint of suppressing the generation of a phase having an RFe₂-type crystal structure, x may be 0.03 or more, 0.04 or more, or 0.05 or more. On the other hand, when x is 0.1 or less, no difficulty is added to the generation of an R₂Fe₁₄B phase. From this viewpoint, x may be 0.09 or less, 0.08 or less, or 0.07 or less. In this way, even when the ratio (molar ratio) of the content of La to the content of R¹ is very small, the effect of suppressing the generation of a phase having an RFe₂-type crystal structure is high. Although not bound by theory, the reason for this is considered to be that even when the content of La in the whole rare earth magnet of the present disclosure is small, La can hardly be a constituent element of the main phase, is readily expelled into the grain boundary phase, and is likely to contribute to suppression of the generation of an RFe₂-type crystal structure-containing phase in the grain boundary phase.

### <Total Content Ratio of R¹ and La>

In the formulae above, the total content ratio of R¹ and La is represented by y and satisfies 12.0≤y≤20.0. Here, the value of y is a content ratio relative to the rare earth magnet of the present disclosure in the case of not diffusing and penetrating a modifier and corresponds to mol % (at %).

When y is 12.0 or more, a sufficient amount of the main phase (R₂Fe₁₄B phase) can be obtained without allowing a large amount of αFe phase to be present. From this viewpoint, y may be 12.4 or more, 12.8 or more, 13.2 or more, or 14.0 or more. On the other hand, when y is 20.0 or less, the grain boundary phase does not become excessive. From this viewpoint, y may be 19.0 or less, 18.0 or less, 17.0 or less, 16.0 or less, or 15.0 or less.

### <B>

B constitutes the main phase 10 (R₂Fe₁₄B phase) in FIG. 1A and affects the content ratios of the main phase 10 and the grain boundary phase 20.

The content ratio of B is represented by w in the formula above. The value of w is a content ratio relative to the rare earth magnet of the present disclosure in the case of not diffusing and penetrating a modifier and corresponds to mol % (at %). When w is 20.0 or less, a rare earth magnet where the main phase 10 and the grain boundary phase 20 are properly present can be obtained. From this viewpoint, w may be 18.0 or less, 16.0 or less, 14.0 or less, 12.0 or less, 10.0 or less, 8.0 or less, 6.0 or less, or 5.9 or less. On the other hand, when w is 5.0 or more, generation of a large amount of a phase having Th₂Zn₁₇-type and/or Th₂Ni₁₇-type crystal structures hardly occurs, as a result, the formation of a R₂Fe₁₄B phase is less inhibited. From this viewpoint, w may be 5.2 or more, 5.4 or more, 5.5 or more, 5.7 or more, or 5.8 or more.

### <M¹>

M¹ is an element that can be contained to an extent of not impairing the properties of the rare earth magnet of the present disclosure. M¹ may contain unavoidable impurity elements. In the present description, the unavoidable impurity elements indicate impurity elements that are unavoidably contained or causes a significant rise in the production cost for avoiding its inclusion, such as impurity elements contained in raw materials of the rare earth magnet or impurity elements having mixed in the production step. The impurity elements, etc. having mixed in the production step encompass one or more elements contained to an extent of not affecting the magnetic properties in terms of production convenience, and the unavoidable impurity elements encompass one or more rare earth elements rather than the rare earth elements selected as R¹ and La, and unavoidably mixed for the above-described reasons, etc.

The element M¹ that can be contained to an extent of not impairing the effects of the rare earth magnet of the present disclosure and the production method thereof includes one or more elements selected from Ga, Al, Cu, Au, Ag, Zn, In, and Mn. As long as these elements are present in an amount not more than the upper limit of the content of M¹, these elements substantially do not affect the magnetic properties. Accordingly, the elements above may be equated with unavoidable impurity elements. Furthermore, besides these elements, unavoidable impurity elements can be contained as M¹. M¹ is preferably one or more elements selected from the group consisting of Ga, Al, and Cu, and unavoidable impurity elements.

In the formula above, the content ratio of M¹ is represented by v. The value of v is a content ratio relative to the rare earth magnet of the present disclosure, where a modifier is not diffused and penetrated, and corresponds to mol % (at %). When the value of v is 2.0 or less, the magnetic properties of the rare earth magnet of the present disclosure are not impaired. From this viewpoint, v may be 1.5 or less, 1.0 or less, 0.65 or less, 0.6 or less, or 0.5 or less.

As for M¹, it is impossible to make the content of Ga, Al, Cu, Au, Ag, Zn, In, Mn, and unavoidable impurity elements zero, and therefore, even if the lower limit of v is 0.05, 0.1, or 0.2, there is no practical problem.

### <Fe>

Fe is a main component constituting the main phase (R₂Fe₁₄B phase) together with R¹, La, B, and the below-described Co. Part of Fe may be replaced by Co.

### <Co>

Co is an element capable of replacing Fe in the main phase and the grain boundary phase. In the present description, unless otherwise indicated, when Fe is referred to, this means that part of Fe can be replaced by Co. For example, part of Fe of the R₂Fe₁₄B phase is replaced by Co to form an R₂(Fe, Co)₁₄B phase.

In a phase having an RFe₂-type crystal structure, part of Fe of the phase is replaced by Co. Although not bound by theory, in a phase having an RFe₂-type crystal structure where part of Fe is replaced by Co, since part of R is replaced by La, the phase is very unstable. Therefore, in the rare earth magnet of the present disclosure, a phase having an RFe₂-type crystal structure is not present or even if it is present, the amount thereof is very small.

Due to the configuration where part of Fe is replaced by Co and the R₂Fe₁₄B phase is thereby changed to an R₂(Fe, Co)₁₄B phase, the Curie point of the rare earth magnet of the present disclosure increases. Therefore, the magnetic properties at high temperatures, particularly, the residual magnetization at high temperatures, of the rare earth element of the present disclosure are enhanced.

### <Molar Ratio of Fe and Co>

When z is 0.1 or more, enhancement of the magnetic properties at high temperatures, particularly, the residual magnetization at high temperatures, achieved due to an increase in the Curie point is substantially recognized. From this viewpoint, z may be 0.12 or more, 0.14 or more, or 0.16 or more. On the other hand, when z is 0.3 or less, the generation of a phase having an RFe₂-type crystal structure can be suppressed due to the coexistence of La. From this viewpoint, z may be 0.28 or less, 0.26 or less, 0.24 or less, 0.22 or less, or 0.20 or less. In addition, since Co is expensive, the above-described range is advantageous.

### <Total Content Ratio of Fe and Co>

The total content ratio of Fe and Co is the remainder after removing hereinbefore-described R¹, La, B, and M¹ and is represented by (100−y−w−v). As described above, the values of y, w and v are content ratios relative to the rare earth magnet of the present disclosure where a modifier is not diffused and penetrated, and therefore, (100−y−w−v) corresponds to mol % (at %). When y, w, and v are in the ranges described above, the main phase 10 and grain boundary phase 20 illustrated in FIG. 1A are obtained.

### <R²>

R² is one or more elements derived from a modifier. The modifier diffuses and penetrates into the inside of a sintered body (the rare earth magnet of the present disclosure in the case of not diffusing and penetrating a modifier) of a magnetic powder. A melt of the modifier diffuses and penetrates through the grain boundary phase 20 of FIG. 1A.

R² is one or more elements selected from the group consisting of Nd, Pr, Gd, Tb, Dy, and Ho. In the case of letting Nd and Pr be present together as R², didymium may be used. The modifier magnetically separates main phases from one another and thereby enhances the coercivity. Accordingly, among the above-described rare earth elements, R² is preferably a heavy rare earth element, more preferably Tb.

### <M²>

M² is one or more metal elements, which are alloyed with R², other than rare earth elements, and unavoidable impurity elements. Typically, M² is one or more alloy elements, which reduce the melting point of R²₍₁₋ₛ₎M²ₛ to be lower than the melting point of R², and unavoidable impurity elements. M² includes, for example, one or more elements selected from Cu, Al, Co, and Fe, and unavoidable impurity elements. From the viewpoint of reducing the melting point of R²₍₁₋ₛ₎M²ₛ, M² is preferably Cu. Incidentally, the unavoidable impurity elements indicate impurity elements that are unavoidably contained or causes a significant rise in the production cost for avoiding its inclusion, such as impurity elements contained in raw materials or impurity elements having mixed in the production step. The impurity elements, etc. having mixed in the production step encompass one or more elements contained to an extent of not affecting the magnetic properties in terms of production convenience, and the unavoidable impurity elements encompass one or more rare earth elements other than the rare earth elements selected as R², and unavoidably mixed for the above-described reasons, etc.

<Molar Ratio of R² and M²>

R² and M² form an alloy having a composition represented, in terms of molar ratio, by the formula: R²₍₁₋ₛ₎M²ₛ, and the modifier contains this alloy, wherein s satisfies 0.05≤s≤0.40.

When s is 0.05 or more, a melt of the modifier can be diffused and penetrated into the inside of a sintered body (the rare earth magnet of the present disclosure in the case of not diffusing and penetrating a modifier) at a temperature where coarsening of the main phase can be avoided. From this viewpoint, s is preferably 0.10 or more, more preferably 0.15 or more. On the other hand, when s is 0.40 or less, the content of M² remaining in the grain boundary phase of the rare earth magnet of the present disclosure after diffusing and penetrating the modifier into the inside of a sintered body (the rare earth magnet of the present disclosure in the case of not diffusing and penetrating a modifier) is reduced, and this contributes to the suppression of reduction in the residual magnetization. From this viewpoint, s may be 0.35 or less, 0.30 or less, 0.25 or less, 0.20 or less, or 0.18 or less.

<Molar Ratio of Element Derived from Sintered Body and Element Derived from Modifier>

As described above, in the case of diffusing and penetrating a modifier, the overall composition of the rare earth magnet of the present disclosure is represented by the formula: (R¹₍₁₋ₓ₎Laₓ)_{y}(Fe_{(1-z)}Co_{z})_{(100-y-w-v)}B_{w}M¹ᵥ.(R²₍₁₋ₛ₎M²ₛ)ₜ. In the formula, the first half (R¹₍₁₋ₓ₎Laₓ)_{y}(Fe_{(1-z)}Co_{z})_{(100-y-w-v)}B_{w}M¹ᵥ represents a composition derived from a sintered body (rare earth magnet precursor) before diffusing and penetrating a modifier, and the last half (R²₍₁₋ₛ₎M²ₛ)ₜ represents a composition derived from a modifier.

In the formula above, the ratio of the modifier relative to 100 parts by mol of the sintered body is t parts by mol. More specifically, when t parts by mol of the modifier is diffused and penetrated into 100 parts by mol of the sintered body, this gives 100 parts by mol+t parts by mol of the rare earth magnet of the present disclosure. In other words, the rare earth magnet of the present disclosure is (100+t) mol % ((100+t) at %) relative to 100 mol % (100 at %) of the sintered body.

When t is 0.1 or more, the effect of magnetically separating main phases from one another to enhance the coercivity can be substantially recognized. From this viewpoint, t may be 0.2 or more, 0.3 or more, 0.4 or more, 0.5 or more, 0.8 or more, 1.0 or more, or 1.2 or more. On the other hand, when t is 10.0 or less, the content of M² remaining in the grain boundary phase of the rare earth magnet of the present disclosure is reduced, and therefore the reduction in the residual magnetization is suppressed. From this viewpoint, t may be 9.0 or less, 8.0 or less, 7.0 or less, 6.0 or less, 5.0 or less, 4.0 or less, 3.0 or less, 2.0 or less, 1.8 or less, 1.6 or less, or 1.4 or less.

As illustrated in FIG. 1A and FIG. 1B, the rare earth magnet 100 of the present disclosure has a main phase 10 and a grain boundary phase 20. The main phase 10 and the grain boundary phase 20 are described below.

### <Main Phase>

The main phase has an R₂Fe₁₄B-type crystal structure. R is one or more rare earth elements. The reason why the crystal structure is expressed as R₂Fe₁₄B“-type” is because in the main phase (in the crystal structure), elements other than R, Fe and B can be contained in a substitution-type and/or interstitial-type manner. For example, in the rare earth magnet of the present disclosure, part of Fe may be replaced by Co in the main phase, or Co may be present as an interstitial-type element in the main phase. Furthermore, in the rare earth magnet of the present disclosure, part of any one element of R, Fe, Co, and B may be replaced by M¹ in the main phase, or, for example, M¹ may be present as an interstitial-type element in the main phase.

The average particle diameter of the main phase is from 1 to 10 μm. The rare earth magnet of the present disclosure is obtained by sintering a magnetic powder at a high temperature of 900 to 1,100° C. or more. When the average particle diameter of the main phase is 1 μm or more, coarsening of the main phase during sintering can be suppressed. From this viewpoint, the average particle diameter of the main phase may be 0.2 μm or more, 0.4 μm or more, 0.6 μm or more, 0.8 μm or more, 1.0 μm or more, 2.0 μm or more, 3.0 μm or more, 4.0 μm or more, 5.0 μm or more, 5.9 μm or more, of 6.0 μm or more. On the other hand, when the average particle diameter of the main phase is 10 μm or less, a reduction in the residual magnetization and coercivity can be suppressed. From this viewpoint, the average particle diameter of the main phase may be 9.0 μm or less, 8.0 μm or less, 7.0 μm or less, 6.5 μm or less, or 6.1 μm or less.

The “average particle diameter” is measured as follows. In a scanning electron microscopic image or a transmission electron microscopic image, a given region observed from a direction perpendicular to the magnetization easy axis is defined, and after a plurality of lines extending in a direction perpendicular to the magnetization easy axis are drawn on main phases present in the given region, the diameter (length) of the main phase is calculated from the distance between intersecting points within particles of the main phase (Hyne method). In the case where the cross-section of the main phase is nearly circular, the diameter is calculated in terms of a projection-area equivalent-circle diameter. In the case where the cross-section of the main phase is nearly rectangular, the diameter is calculated in terms of rectangle approximation. The value of D₅₀ of the thus-obtained diameter (length) distribution (grain size distribution) is the average particle diameter.

The contact surface 15 between the main phase 10 and the grain boundary phase 20 illustrated in FIG. 1B is preferably a facet interface. When the contact surface 15 is a facet interface, the coercivity at high temperatures is enhanced.

Whether the contact surface 15 is a facet interface or not can be determined by the microstructure parameter α. When the microstructure parameter α is 0.30 or more, the contact surface 15 is a facet interface, and the coercivity at high temperatures is enhanced. From this viewpoint, α may be 0.32 or more, 0.35 or more, 0.37 or more, 0.38 or more, 0.39 or more, or 0.40 or more. On the other hand, even if the contact surface 15 is not a complete facet interface (complete flat surface), the coercivity at high temperatures is enhanced. From this viewpoint, a may be 0.70 or less, 0.65 or less, 0.61 or less, 0.60 or less, 0.55 or less, 0.50 or less, 0.49 or less, or 0.46 or less.

It is generally known that the microstructure parameter α is calculated by the Kronmuller formula. The Kronmuller formula is represented by H_{c}=α·Hₐ−N_{eff}·Mₛ (wherein H_{c} is the coercivity, Hₐ is the anisotropic magnetic field, Mₛ is the saturation magnetization, and N_{eff} is the self-demagnetizing field coefficient). The Kronmuller formula represents the relationship between the magnetic properties (not dependent on the microstructure of the magnet) possessed by a magnetic phase and the magnetic separation properties (dependent on the microstructure of the magnet) of the magnetic phase by focusing attention on the fact that the hysteresis curve changes depending on the temperature. The microstructure parameter a is an index indicating the shape of the interface (whether a facet interface or not) between the magnetic phase and a phase other than the magnetic phase and the crystallinity, and N_{eff} is an index indicating the size of the magnetically separated region, i.e., the magnetic separation properties of the magnetic phase. Here, the “magnetic phase” means the main phase 10 in FIG. 1A and FIG. 1B. In addition, the “interface between the magnetic phase and a phase other than the magnetic phase” means the contact surface 15 in FIG. 1A and FIG. 1B. Incidentally, “u” in the Kronmuller formula is originally u-umlaut but for convenience in writing, is indicated by “u”.

The property of the contact surface 15, i.e., the microstructure parameter α, changes depending on the production conditions of the rare earth magnet. Details of the relationship between the contact surface 15 property and the production conditions of the rare earth magnet are described later in the paragraph “<<Production Method>>”.

### <Grain Boundary Phase>

As illustrated in FIG. 1A, the rare earth magnet 100 of the present disclosure has a main phase 10 and a grain boundary phase 20 present around the main phase 10. As described above, the main phase 10 contains a magnetic phase (R₂Fe₁₄B phase) having an R₂Fe₁₄B-type crystal structure. On the other hand, the grain boundary phase 20 contains a phase with the crystal structure being indistinct, including a phase having a crystal structure other than the R₂Fe₁₄B type. Although not bound by theory, the “indistinct phase” means a phase (state) in which at least part of phases have an incomplete crystal structure and these phases are irregularly present, or means a phase in which at least part of the phase (state) above almost fails to present the appearance of a crystal structure as if it is an amorphous phase. With respect to the phases present in the grain boundary phase 20, in both a phase have a crystal structure other than the R₂Fe₁₄B type and a phase with the crystal structure being indistinct, the content ratio of R is higher than in a phase having an R₂Fe₁₄B-type crystal structure. For this reason, the grain boundary phase 20 is sometimes referred to as an “R-rich phase”, a “rare earth element-rich phase”, or a “rare earth-rich phase”.

As illustrated in FIG. 1B and FIG. 8B, both the rare earth magnet 100 of the present disclosure and the conventional rare earth magnet 200 have a main phase 10 and a grain boundary phase 20. In addition, the grain boundary phase 20 has an adjacent part 22 and a triple point 24.

In both a case where a molten alloy having a composition of the rare earth magnet 100 of the present disclosure is solidified and a case where a molten alloy having a composition of the conventional rare earth magnet 200, common is that when the main phase 10 is generated, the residual melt is present in the adjacent part 22 and the triple point 24. However, the phase generated as a result of solidification of the residual melt differs between a case of solidifying a molten alloy having a composition of the rare earth magnet 100 of the present disclosure and a case of solidifying a molten alloy having a composition of the conventional rare earth magnet 200.

In the case where a molten alloy having a composition of the conventional rare earth magnet 200 is solidified, many phases having an RFe₂-type crystal structure are generated in the adjacent part 22. In the adjacent part 22, in addition to a phase having an RFe₂-type crystal structure, a phase having a crystal structure other than R₂Fe₁₄B type and RFe₂ type, where the content ratio of R is higher than in the phase having an R₂Fe₁₄B-type crystal structure, is present. In the triple point 24, many phases having a crystal structure other than R₂Fe₁₄B type and RFe₂ type, where the abundance ratio of R is higher than in the phase having an R₂Fe₁₄B-type crystal structure, are present. On the other hand, in the case where a molten alloy having a composition of the rare earth magnet 100 of the present disclosure is solidified, many phases having a crystal structure other than R₂Fe₁₄B type, where the content ratio of R is higher than in the phase having an R₂Fe₁₄B-type crystal structure, are generated in both the adjacent part 22 and the triple point 24. However, since Co and La are present together in the molten alloy having a composition of the rare earth magnet 100 of the present disclosure, in both the adjacent part 22 and the triple point 24, a phase having an RFe₂-type crystal structure may not be generated, or even if it is generated, the generation amount thereof is very small.

The content (generation amount) of a phase having an RFe₂-type crystal structure is evaluated by the volume ratio of a phase having an RFe₂-type crystal structure relative to the grain boundary phase. The volume ratio of a phase having an RFe₂-type crystal structure is determined as follows. The volume fraction of a phase having an RFe₂-type crystal structure is determined by Rietveld analysis of an X-ray diffraction pattern of the rare earth magnet of the present disclosure. In addition, the volume fraction of the main phase is calculated from the content ratio of the rare earth element and boron. Then, assuming the phase other than the main phase in the rare earth magnet of the present disclosure is a grain boundary phase, the volume fraction of the grain boundary phase is calculated. From these, (volume fraction of phase having RFe₂-type crystal structure)/(volume fraction of grain boundary phase) is calculated, and the obtained values is defined as the volume ratio of a phase having an RFe₂-type crystal structure relative to the grain boundary phase.

In the rare earth magnet of the present disclosure, the volume ratio of a phase having an RFe₂-type crystal structure is 0.6 or less relative to the grain boundary phase. Since the squareness is impaired due to the presence of a phase having an RFe₂-type crystal structure, the volume ratio of a phase having an RFe₂-type crystal structure is preferably as low as possible. Therefore, when the volume ratio is 0.60 or less, 0.54 or less, 0.52 or less, 0.50 or less, 0.45 or less, or 0.40 or less, the squareness ratio is 05 or more, and the squareness is excellent. On the other hand, in view of squareness, the volume ratio of a phase having an RFe₂-type crystal structure is ideally 0. However, as long as the upper limit of the volume ratio of a phase having an RFe₂-type crystal structure satisfies the above-described value, even when the volume ratio of a phase having an RFe₂-type crystal structure is 0.05 or more, 0.10 or more, or 0.15 or more, there is no practical problem. Incidentally, the squareness ratio is Hr/Hc. Hc is the coercivity, and Hr is the magnetic field at a 5% demagnetization. The magnetic field at a 5% demagnetization means a magnetic field of a second quadrant (demagnetization curve) of a hysteresis curve when the magnetization is reduced by 5% from the residual magnetization (the magnetic field when the applied magnetic field is 0 kA/m).

### <<Production Method>>

The production method of the rare earth magnet of the present disclosure is described below.

The production method of the rare earth magnet of the present disclosure includes respective steps of preparation of a molten alloy, cooling of the molten alloy, pulverization, and sintering. A sintered body obtained by the sintering may be used as the rare earth magnet of the present disclosure. Alternately, a modifier may be diffused and penetrated into the sintered body, and a sintered body after the diffusion and penetration may be used as the rare earth magnet of the present disclosure. In the case of diffusing and penetrating a modifier, respective steps of preparing a modifier and diffusing/penetrating the modifier are added. In the following, each step is described. For the diffusion and penetration of a modifier, a so-called “two-alloy method” can be applied. The two-alloy method is described together. In addition, optionally, the sintered body may be heat-treated under predetermined conditions. In the case of not diffusing and penetrating a modifier, the sintered body may be heat-treated under predetermined conditions, and the sintered body after the heat treatment may be used as the rare earth magnet of the present disclosure. In the case of diffusing and penetrating a modifier, the sintered body before or after the diffusion and penetration of a modifier may be heat-treated under predetermined conditions. The heat treatment under predetermined conditions is described together.

### <Preparation of Molten Alloy>

A molten alloy having a composition represented, in terms of molar ratio, by the formula: (R¹₍₁₋ₓ₎Laₓ)_{y}(Fe_{(1-z)}Co_{z})_{(100-y-w-v)}B_{w}M¹ᵥ s prepared. In the formulae, R¹, La, Fe, Co, B, M¹, x, y, z, w, and v are as described in “<<Rare Earth Magnet>>”. With regard to the element that may be consumed in the subsequent process, the molten alloy composition can be made up in consideration of the consumption.

### <Cooling of Molten Alloy>

The molten alloy having the above-described composition is cooled at a rate of 1 to 10⁴° C./sec. Cooling at such a rate enables obtaining a magnetic ribbon or thin magnetic strip having main phases with an average particle diameter of 1 to 10 μm. From the viewpoint of obtaining main phases having an average particle of 1 μm or more, the molten alloy may be cooled at a rate of 5×10³° C./sec or less, 10³° C./sec or less, or 5° C.×10²° C./sec or less. On the other hand, from the viewpoint of obtaining main phases having an average particle diameter of 10 or less, the molten alloy may be cooled at a rate of 5° C./sec or more, 10° C./sec or more, or 10²° C./sec or more. In addition, the main phase is a phase having an R₂Fe₁₄B-type crystal structure, and a grain boundary phase is present around the main phase. A phase having an RFe₂-type crystal structure is not present in the grain boundary phase, and even if it is present, the amount thereof is very small. Cooling of the molten alloy at the rate above contributes to obtaining such main phase and grain boundary phase.

As long as the molten alloy can be cooled at the above-described rate, the method therefor is not particularly limited, but, typically, the method includes a method using a book mold, a strip casting method, etc. From the viewpoint that the rate above can be stably obtained and a large amount of molten alloy can be continuously cooled, a strip casting method is preferred.

The book mold is a casting mold having a flat plate-like cavity. The thickness of the cavity may be appropriately decided so that the cooling rate above can be obtained. The thickness of the cavity may be, for example, 0.5 mm or more, 1 mm or more, 2 mm or more, 3 mm or more, 4 mm or more, or 5 mm or more, and may be 20 mm or less, 15 mm or less, 10 mm or less, 9 mm or less, 8 mm or less, 7 mm or less, or 6 mm or less.

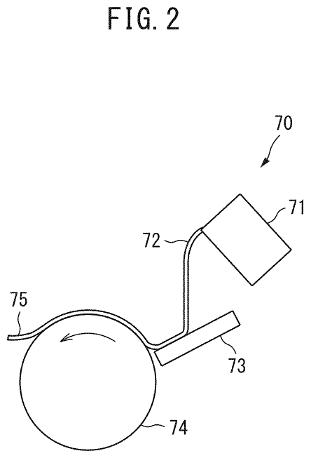

The strip casting method is described below using a drawing. FIG. 2 is an explanatory diagram schematically illustrating the cooling apparatus used for a strip casting method.

The cooling apparatus 70 has a melting furnace 71, a tundish 73, and a cooling roll 74. Raw materials are melted in the melting furnace 71 to prepare a molten alloy 72 having the above-described composition. The molten alloy 72 is fed at a constant feed rate to the tundish 73. The molten alloy 72 fed into the tundish 73 is fed by its self-weight from the edge of the tundish 73 to the cooling roll 74.

The tundish 73 is composed of ceramic, etc. and can temporarily store the molten alloy 72 continuously fed from the melting furnace 71 at a predetermined flow rate and rectify the flow of the molten alloy 72 to the cooling roll 74. The tundish 73 also has a function of adjusting the temperature of the molten alloy 72 immediately before reaching the cooling roll 74.

The cooling roll 74 is formed of a material having high thermal conductivity, such as copper or chromium, and the surface of the cooling roll 74 is subjected to chromium plating, etc. so as to prevent corrosion by the high-temperature molten alloy. The cooling roll 74 is rotated by a drive unit (not shown) at a predetermined rotational speed in the arrow direction.

In order to obtain the above-described cooling rate, the peripheral velocity of the cooling roll 74 may be 0.5 m/s or more, 1.0 m/s or more, or 1.5 m/s or more, and may be 3.0 m/s or less, 2.5 m/s or less, or 2.0 m/s or less.

The temperature of the molten alloy when fed to the cooling roll 74 from the edge of the tundish 73 may be 1,350° C. or more, 1,400° C. or more, or 1,450° C. or more, and may be 1,600° C. or less, 1,550° C. or less, or 1,500° C. or less.

The molten alloy 72 cooled and solidified on the outer circumference of the cooling roll 74 turns into a magnetic alloy 75 and is separated from the cooling roll 74 and collected in a collection unit (not shown). The form of the magnetic alloy 75 is typically a ribbon or a thin strip. The atmosphere at the time of cooling the molten alloy by using a strip casting method is preferably an inert gas atmosphere so as to prevent oxidation, etc. of the molten alloy. The inert gas atmosphere encompasses a nitrogen gas atmosphere.

### <Pulverization>

The magnetic ribbon or thin magnetic strip obtained as above is pulverized to obtain a magnetic powder. The method for pulverization is not particularly limited but includes, for example, a method where the magnetic ribbon or thin magnetic strip is coarsely pulverized and then further pulverized by means of a jet mill and/or a cutter mill, etc. The method for coarse pulverization includes, for example, a method using a hammer mill, and a method where the magnetic ribbon and/or thin magnetic strip is hydrogen-embrittled/pulverized. These methods may also be used in combination.

The particle diameter of the magnetic powder after pulverization is not particularly limited as long as the magnetic powder can be sintered. The particle diameter of the magnetic powder may be, for example, in terms of D₅₀, 1 μm or more, 5 μm or more, 10 μm or more, 20 μm or more, 30 μm or more, 40 μm or more, 50 μm or more, 60 μm or more, 70 μm or more, 80 μm or more, or 90 μm or more, and may be 3,000 μm or less, 2,000 μm or less, 1,000 μm or less, 900 μm or less, 800 μm or less, 700 μm or less, 600 μm or less, 500 μm or less, 400 μm or less, 300 μm or less, 200 μm or less, or 100 μm or less.

### <Sintering>

The magnetic powder is sintered at 900 to 1,100° C. to obtain a sintered body. In order to increase the density of the sintered body by performing pressureless sintering, the magnetic powder is sintered at a high temperature over a long period of time. The sintering temperature may be, for example, 900° C. or more, 950° C. or more, or 1,000° C. or more, and may be 1,100° C. or less, 1,050° C. or less, or 1,040° C. or less. The sintering time may be, for example, 1 hour or more, 2 hours or more, 3 hours or more, or 4 hours or more, and may be 24 hours or less, 18 hours or less, 12 hours or less, or 6 hours or less. In order to suppress oxidation of the magnetic powder during sintering, the sintering atmosphere is preferably an inert gas atmosphere. The inert gas atmosphere encompasses a nitrogen gas atmosphere.

In order to increase the density of the sintered body, typically, the magnetic powder is previously compacted before sintering, and the obtained powder compact is sintered. The molding pressure during powder compacting may be, for example, 50 MPa or more, 100 MPa or more, 200 MPa or more, or 300 MPa or more, and may be 1,000 MPa or less, 800 MPa or less, or 600 MPa or less. In order to impart anisotropy to the sintered body, powder compacting may also be performed while applying a magnetic field to the magnetic powder. The magnetic field applied may be 0.1 T or more, 0.5 T or more, 1.0 T or more, 1.5 T or more, or 2.0 T or more, and may be 10.0 T or less, 8.0 T or less, 6.0 T or less, or 4.0 T or less.

### <Preparation of Modifier>

A modifier having a composition represented, in terms of molar ratio, by the formula: R²₍₁₋ₛ₎M²ₛ is prepared. In the formula representing the composition of the modifier, R², M² and s are as described in “<<Rare Earth Magnet>>”.

The method for preparing the modifier includes, for example, a method where a ribbon and/or a thin strip, etc. is obtained from a molten alloy having a composition of the modifier by using a liquid quenching method or a strip casting method, etc. This method is advantageous in that since the molten alloy is quenched, segregation is less likely to occur in the modifier. In addition, the method for preparing the modifier includes, for example, a method where a molten alloy having a composition of the modifier is cast in a casting mold such as book mold, etc. In this method, a large amount of modifier is relatively easily obtained. In order to reduce the segregation of the modifier, the book mold is preferably made of a material having a high thermal conductivity. Also, the cast material is preferably heat-treated for homogenization so as to suppress segregation. Furthermore, the method for preparing the modifier includes a method where raw materials of the modifier are loaded into a container, the raw materials are arc-melted in the container, and the melted product is cooled to obtain an ingot. In this method, even when the melting point of the raw material is high, the modifier can relatively easily be obtained. From the viewpoint of reducing segregation of the modifier, the ingot is preferably heat-treated for homogenization.

### <Diffusion and Penetration>

The modifier is diffused and penetrated into the sintered body obtained by sintering the magnetic powder. As the method for diffusion and penetration, typically, the modifier is put into contact with the sintered body to obtain a contact body, and the contact body is heated to diffuse and penetrate a melt of the modifier into the inside of the sintered body. The melt of the modifier diffuses and penetrates through the grain boundary phase 20 in FIG. 1A. Then, the melt of the modifier solidifies in the grain boundary phase 20 to magnetically separate main phase 10 from one another, as a result, the coercivity, particularly, the coercivity at high temperatures, is enhanced.

The embodiment of the contact body is not particularly limited as long as the modifier is in contact with the sintered body. The embodiment of the contact body includes, for example, an embodiment where a modifier ribbon and/or thin strip obtained by a strip casting method is brought into contact with the sintered body, and an embodiment where a modifier powder obtained by pulverizing a strip cast material, a book molded material and/or an arc-melted/solidified material is brought into contact with the sintered body.

The diffusion and penetration temperature is not particularly limited as long as it is a temperature at which the modifier diffuses and penetrates into the inside of the sintered body and the main phase is not coarsened. Typically, the diffusion and penetration temperature is not less than the melting point of the modifier and not more than the sintering temperature of the magnetic powder. The diffusion and penetration temperature may be, for example, 750° C. or more, 775° C. or more, or 800° C. or more, and may be 1,000° C. or less, 950° C. or less, 925° C. or less, or 900° C. or less.

The diffusion and penetration of the modifier may also serve as a heat treatment under the later-described conditions. In this case, the heating and cooling conditions of the modifier are set to the same conditions as in the heat treatment under predetermined conditions. This not only enables the diffusion and penetration of the modifier to magnetically separate main phases from one another but also makes the contact surface between the main phase and the grain boundary phase be a facet interface, as a result, the coercivity, particularly, the coercivity at high temperatures, is further enhanced.

At the time of diffusion and penetration of the modifier, t parts by mol of the modifier is brought into contact with the sintered body per 100 parts by mol of the sintered body. t is as described in “<<Rare Earth Magnet>>”.

Since the modifier is diffused and penetrated at a temperature where the main phase of the sintered body is not coarsened, the average particle diameter of main phases before the diffusion and penetration of the modifier and the average particle diameter of main phases after the diffusion and penetration of the modifier are substantially in the same size range. The average particle diameter and crystal structure of the main phase are as described in “<<Rare Earth Magnet>>”.

During diffusion and penetration of the modifier, the diffusion and penetration atmosphere is preferably an inert gas atmosphere so as to suppress oxidation of the sintered body and modifier. The inert gas atmosphere encompasses a nitrogen gas atmosphere.

### <Two-Alloy Method>

Instead of diffusing and penetrating the modifier into the sintered body, it may also be possible to mix a magnetic powder and a modifier powder to obtain a mixed powder and sinter the mixed powder to obtain a sintered body.

As for the magnetic powder mixed with the modifier powder, the same as in the case of sintering the magnetic powder can be used. The modifier powder is obtained as follows.

A modifier powder having a composition represented, in terms of molar ratio, by the formula: R²₍₁₋ₛ₎M²ₛ is prepared. In the formula representing the composition of the modifier powder, R², M² and s are as described in “<<Rare Earth Magnet>>”.

The method for preparing the modifier powder includes, for example, a method where a ribbon, etc. is obtained from a molten alloy having a composition of the modifier powder by using a liquid quenching method or a strip casting method, etc. and the ribbon is pulverized. In this method, the molten alloy is quenched, and therefore segregation is less likely to occur in the modifier powder. In addition, the method for preparing the modifier powder includes, for example, a method where a molten alloy having a composition of the modifier powder is cast in a casting mold such as book mold, etc. and the cast material is pulverized. In this method, a large amount of modifier powder is relatively easily obtained. In order to reduce the segregation in the modifier powder, the book mold is preferably made of a material having a high thermal conductivity. Also, the cast material is preferably heat-treated for homogenization so as to suppress segregation. Furthermore, the method for preparing the modifier powder includes a method where raw materials of the modifier powder are loaded into a container, the raw materials are arc-melted in the container, the melted product is cooled to obtain an ingot, and the ingot is pulverized. In this method, even when the melting point of the raw material is high, the modifier powder can relatively easily be obtained. From the viewpoint of reducing segregation of the modifier powder, the ingot is preferably heat-treated for homogenization.

The magnetic powder and the modifier powder are mixed, and the mixed powder is sintered. After the mixing, the mixed powder of the magnetic powder and the modifier powder may be compacted before sintering.

Powder compacting may also be performed in a magnetic field. Powder compacting in a magnetic field enables imparting anisotropy to the powder compact, as a result, anisotropy can be imparted to the sintered body. The molding pressure during powder compacting may be, for example, 50 MPa or more, 100 MPa or more, 200 MPa or more, or 300 MPa or more, and may be 1,000 MPa or less, 800 MPa or less, or 600 MPa or less. The magnetic field applied may be 0.1 T or more, 0.5 T or more, 1.0 T or more, 1.5 T or more, or 2.0 T or more, and may be 10.0 T or less, 8.0 T or less, 6.0 T or less, or 4.0 T or less.

The powder compact obtained as above is pressureless sintered to obtain a sintered body. In order to increase the density of the sintered body by performing pressureless sintering, the powder compact is sintered at a high temperature over a long period of time. The sintering temperature may be, for example, 900° C. or more, 950° C. or more, or 1,000° C. or more, and may be 1,100° C. or less, 1,050° C. or less, or 1,040° C. or less. The sintering time may be, for example, 1 hour or more, 2 hours or more, 3 hours or more, or 4 hours or more, and may be 24 hours or less, 18 hours or less, 12 hours or less, or 6 hours or less. In order to suppress oxidation of the powder compact during sintering, the sintering atmosphere is preferably an inert gas atmosphere. The inert gas atmosphere encompasses a nitrogen gas atmosphere.

When pressureless sintering is performed in this way, not only a sintered boy is merely obtained but also the modifier diffuses and penetrates though the grain boundary phase in the magnetic powder. Consequently, main phases are magnetically separated, and the coercivity, particularly, the coercivity at high temperatures, is enhanced.

At the time of sintering of the mixed powder, t parts by mol of the modifier powder is mixed per 100 parts by mol of the magnetic powder, and the mixed powder is sintered. t is as described in “<<Rare Earth Magnet>>”.

Since the mixed powder is sintered at a temperature where the main phase of the magnetic powder is not coarsened, the average particle diameter of main phases before the sintering and the average particle diameter of main phases after the sintering are substantially in the same size range. The average particle diameter and crystal structure of the main phase are as described in “<<Rare Earth Magnet>>”.

### <Heat Treatment>

Optionally, the sintered body may be heat-treated under predetermined conditions (hereinafter, this heat treatment is sometimes referred to as “specific heat treatment”). The specific heat treatment can make the contact surface between the main phase and the grain boundary phase be a facet interface and enhance the coercivity, particularly, the coercivity at high temperatures.

The specific heat treatment can be applied to the sintered body, and a sintered body before the diffusion and penetration of a modifier may be subjected to the specific heat treatment, or a sintered body after the diffusion and penetration of a modifier may be subjected to the specific heat treatment. Also, a sintered body obtained by the two-alloy method may be subjected to the specific heat treatment. The diffusion and penetration of the modifier may also serve as the specific heat treatment, and in this case, the modifier is diffused and penetrated under the same conditions as in the specific heat treatment. In addition, the specific heat treatment may be performed a plurality of times. For example, in the case where the diffusion and penetration of the modifier serves as the specific heat treatment, the sintered body into which the modifier has been diffused and penetrated may be further subjected to the specific heat treatment. Alternatively, in the case of diffusing and penetrating a modifier into the sintered body, the specific heat treatment may be performed both before and after the diffusion and penetration of the modifier. More specifically, in the case of diffusing and penetrating the modifier into the sintered material, the specific heat treatment may be performed at least either before or after diffusing and penetrating the modifier. In addition, in either case, the specific heat treatment may be performed by heating the sintered body from room temperature, or without cooling the sintered body to room temperature, the sintered body may be subjected to the specific heat treatment subsequently to the previous step.

As for the conditions of the specific heat treatment, the sintered body is held at 850 to 1,000° C. over 50 to 300 minutes and then cooled at a rate of 0.1 to 5.0° C./min to 450 to 700° C.

When the holding temperature is 850° C. or more, part of the grain boundary phase, particularly, a vicinity of the contact surface between the main phase and the grain boundary phase, can be melted. From this viewpoint, the holding temperature may be 900° C. or more, 920° C. or more, or 940° C. or more. On the other hand, when the holding temperature is 1,000° C. or less, coarsening of the main phase can be avoided. From this viewpoint, the holding temperature may be 990° C. or less, 980° C. or less, 970° C. or less, or 950° C. or less.

When the holding time is 50 minutes or more, a vicinity of the contact surface between the main phase and the grain boundary phase starts melting during the holding. From this viewpoint, the holding time may be 60 minutes or more, 80 minutes or more, 100 minutes or more, 120 minutes or more, or 140 minutes or more. On the other hand, when it is 300 minutes or less, coarsening of the main phase can be avoided. From this viewpoint, the holding time may be 250 minutes or less, 200 minutes or less, 180 minutes or less, or 160 minutes or less.

As the sintered body is possibly slowly cooled from the above-described holding temperature to the temperature region of 450 to 700° C., the contact surface between the main phase and the grain boundary phase is likely to become a facet interface. From this viewpoint, the cooling rate may be 5.0° C./min or less, 4.0° C./min or less, 3.0° C./min or less, 2.0° C./min or less, 1.0° C./min or less, 0.9° C./min or less, 0.8° C./min or less, 0.7° C./min or less, 0.6° C./min or less, 0.5° C./min or less, 0.4° C./min or less, 0.3° C./min or less, or 0.2° C./min or less. On the other hands, in view of manufacturability, the cooling rate may be 0.1° C./min or more.

From the viewpoint of obtaining a facet interface, the slow cooling end temperature may be 450° C. or more, 500° C. or more, or 550° C. or more, and may be 750° C. or less, 700° C. or less, 650° C. or less, or 600° C. or less.

After cooling to 450 to 700° C., the sintered body may be directly cooled to room temperature. At this time, the cooling rate is not particularly limited. Alternatively, after cooling to 450 to 700° C., the sintered body may be held in this temperature range for a given time and then held until room temperature. When the sintered body is held in the range of 450 to 700° C. for a given time, the components of the grain boundary phase diffuse between main phases, and the main phase is more firmly surrounded by the components of the grain boundary phase, as a result, the coercivity is further enhanced. From this viewpoint, the holding temperature may be 450° C. or more, 500° C. or more, or 550° C. or more, and may be 750° C. or less, 700° C. or less, 650° C. or less, or 600° C. or less. In addition, the holding time may be 10 minutes or more, 20 minutes or more, 30 minutes or more, 40 minutes or more, or 50 minutes or more, and may be 300 minutes or less, 250 minutes or less, 200 minutes or less, 180 minutes or less, 160 minutes or less, 140 minutes or less, 120 minutes or less, 100 minutes or less, 80 minutes or less, or 60 minutes or less. Furthermore, a cycle consisting of holding using the above-described temperature and time, cooling to room temperature, again holding using the temperature and time above, and cooling to room temperature may be performed a plurality of times.

In order to suppress oxidation of the sintered body during the specific heat treatment, the specific heat treatment atmosphere is preferably an inert gas atmosphere. The inert gas atmosphere encompasses a nitrogen gas atmosphere.

### <Modification>

Other than those described hereinbefore, in the rare earth magnet of the present disclosure and the production method thereof, various modifications can be added within the scope of contents as set forth in claims. For example, a modifier may be further diffused and penetrated into a sintered body obtained by a two-alloy method. At this time, the diffusion and penetration of a modifier may also serve as the specific heat treatment.

### EXAMPLES

The rare earth magnet of the present disclosure and the production method thereof are described more specifically below by referring to Examples and Comparative Examples. Note that the rare earth magnet of the present disclosure and the production method thereof are not limited to the conditions employed in the following Examples.

### <Preparation of Sample>

The samples of Examples 1 to 6 and Comparative Examples 1 to 7 were prepared by the following procedure. Incidentally, the samples of Examples 1 to 4 and Comparative Examples 1 to 4 are samples where a modifier was not diffused and penetrated, and the samples of Examples 5 and 6 and Comparative Examples 5 to 7 are samples where a modifier was diffused and penetrated.

### Preparation of Samples of Examples 1 to 4 and Comparative Examples 1 to 4

A strip cast material (magnetic ribbon) having a composition shown in Table 1 was prepared. The strip cast material was coarsely pulverized by hydrogen embrittlement and then further pulverized using a jet mill to obtain a magnetic powder. When the molten alloy was cooled using a strip casting method, the cooling rate of the molten alloy was 10³° C./sec. Furthermore, the particle diameter of the magnetic powder was 3.0 μm in terms of D₅₀.

The magnetic powder was subjected to pressureless sintering (pressureless liquid phase sintering) at 1,050° C. over 4 hours. After the sintering, the sintered body cooled to room temperature was subjected to the specific heat treatment. As for the conditions of the specific heat treatment, the sintered body was held at 950° C. (first holding temperature) over 160 seconds and then cooled at a rate of 1.0° C./min to 500 to 650° C. Furthermore, the sintered body was held at a second holding temperature shown in Table 1 over 60 seconds and then allowed to cool.

### Preparation of Samples Examples 5 and 6 and Comparative Examples 5 to 7

A strip cast material (magnetic ribbon) having a composition shown in Table 2 was prepared. The strip cast material was coarsely pulverized by hydrogen embrittlement and then further pulverized using a jet mill to obtain a magnetic powder. When the molten alloy was cooled using a strip casting method, the cooling rate of the molten alloy was 10³° C./sec. Furthermore, the particle diameter of the magnetic powder was 3.0 μm in terms of D₅₀.

The magnetic powder was subjected to pressureless sintering (pressureless liquid phase sintering) at 1,050° C. over 4 hours. After the sintering, a modifier was diffused and penetrated into the sintered body which had been cooled to room temperature. At the time of performing the diffusion and penetration, a contact body obtained by bringing a modifier ribbon into contact with the sintered body was held at 950° C. over 165 minutes. Then, the contact body was cooled at a rate of 1.0° C./min to 500 to 650° C. to effect both the specific heat treatment and the diffusion and penetration of the modifier. Furthermore, the sintered body was held at a second holding temperature shown in Table 2 over 60 seconds and then allowed to cool. The composition of the modifier was Tb_{0.82}Cu_{0.18}, and the amount of the modifier diffused and penetrated was 1.4 parts by mol per 100 parts by mol of the sintered body.

### <<Evaluation>>

The magnetic properties of each sample were measured at 300 K and 453 K using Vibrating Sample Magnetometer (VSM). The residual magnetization at 453 K was evaluated by the temperature coefficient of residual magnetization. The temperature coefficient of residual magnetization is a value calculated according to the formula: [{(residual magnetization at 453 K)−(residual magnetization at 300 K)}/(453 K−300 K)]×100. As the absolute value of the temperature coefficient of residual magnetization is smaller, the reduction in the residual magnetization at high temperatures is lesser, and the absolute value of the temperature coefficient of residual magnetization is preferably 0.1 or less.

Each sample was determined for the average particle dimeter of main phases by performing SEM (Scanning Electron Microscope) observation. In addition, each sample was determined for the volume fraction of a phase having an RFe₂-type crystal structure by performing an X-ray diffraction analysis, and also, a volume ratio of a phase having an RFe₂-type crystal structure relative to the grain boundary phase was determined by the method described in “<<Rare Earth Magnet>>”. Furthermore, each sample was determined for the microstructure parameter α.

The samples of Example 2 and Comparative Example 3 were analyzed (line analysis) for the compositions of the main phase and the grain boundary phase using SEM-EDX (Scanning Electron Microscope-Energy Dispersive X-ray Spectroscope). Furthermore, with respect to the sample of Example 2, the contact surface between the main phase and the grain boundary phase was observed by TEM (Transmission Electron Microscope).

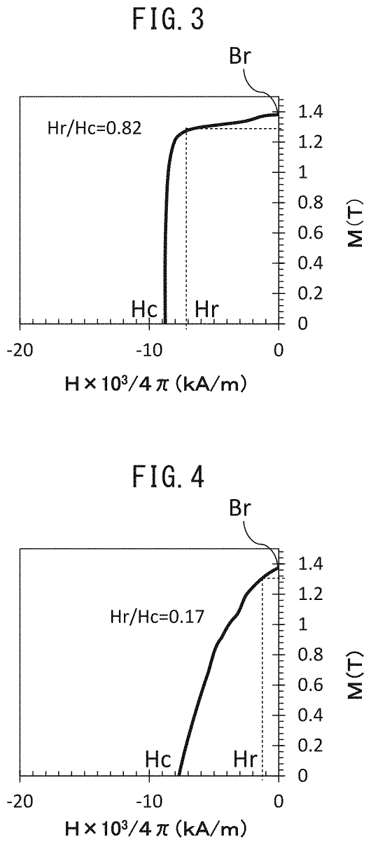

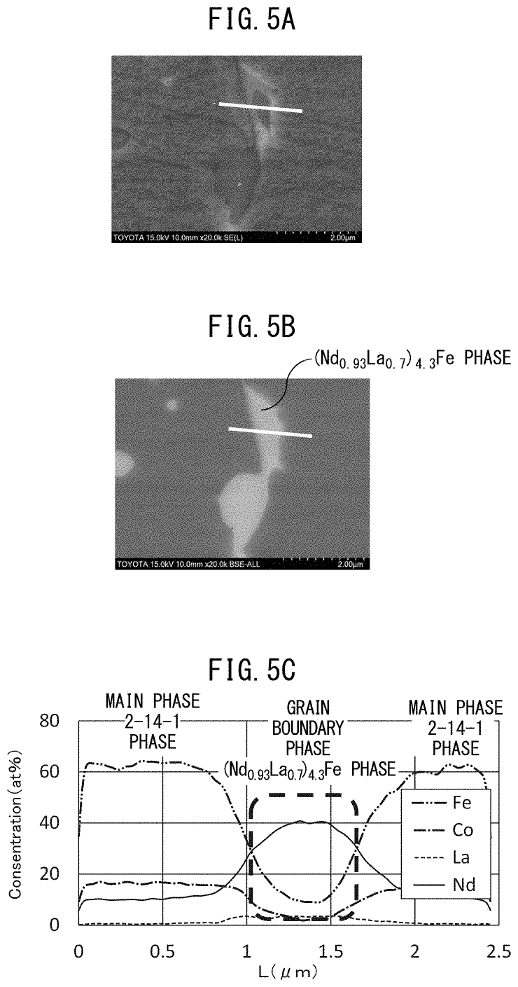

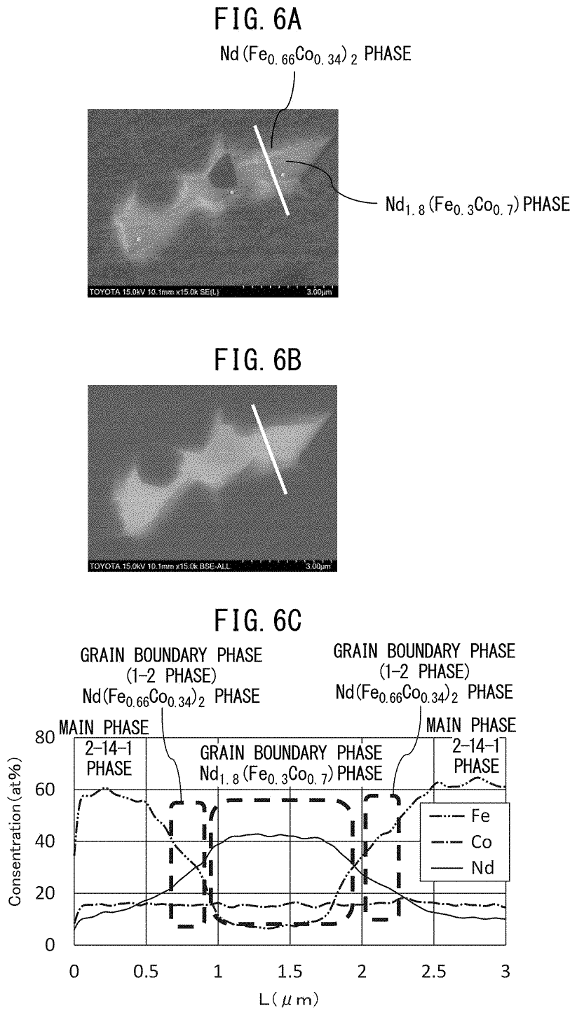

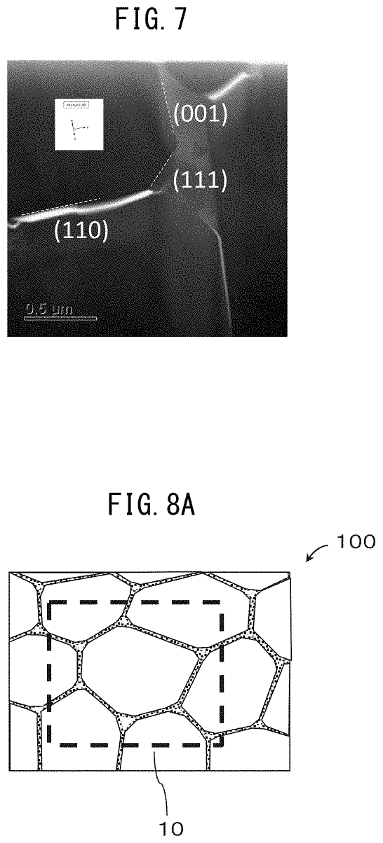

The results are shown in Tables 1-1 and 1-2 and Tables 2-1 and 2-2. FIG. 3 is a graph illustrating a demagnetization curve of the sample of Example 2. FIG. 4 is a graph illustrating a demagnetization curve of the sample of Comparative Example 3. FIG. 5A is an SEM image illustrating the SEM observation results of the sample of Example 2. FIG. 5B is a backscattered electron image illustrating the SEM observation results of the sample of Example 2. FIG. 5C is a graph illustrating the results of SEM-EDX analysis (line analysis) of the part shown by a white line in FIG. 5A and FIG. 5B. FIG. 6A is an SEM image illustrating the SEM observation results of the sample of Comparative Example 3. FIG. 6B is a backscattered electron image illustrating the SEM observation results of the sample of Comparative Example 3. FIG. 6C is a graph illustrating the results of SEM-EDX analysis (line analysis) of the part shown by a white line in FIG. 6A and FIG. 6B. FIG. 7 is a TEM image illustrating the results of microstructure observation of a vicinity of the contact surface between the main phase and the grain boundary phase regarding the sample of Example 2. Here, in FIG. 5C and FIG. 6C, the 2-14-1 phase means a phase having an R₂Fe₁₄B-type crystal structure, i.e., the main phase. Also, in FIG. 6C, the 1-2 phase means a phase having an RFe₂-type crystal structure.

TABLE 1-1

| | Composition of Rare Earth Magnet | |
|---|---|---|
| | Representation 1 | Representation 2 |
| | (molar ratio) | (molar ratio) |
| Comparative | Nd_{11.3}Pr_{2.6}Fe_{bal}Co_{0.8}B_{5.9}Cu_{0.15}Al_{0.2}Ga_{0.3} | (Nd_{0.81}Pr_{0.19})_{13.9}(Fe_{0.99}Co_{0.01})_{79.55}B_{5.9}Cu_{0.15}Al_{0.2}Ga_{0.3} |
| Example 1 | | |
| Comparative | Nd_{11.5}Pr_{2.7}Fe_{bal}Co_{7.8}B_{5.8}Cu_{0.15}Al_{0.2}Ga_{0.3} | (Nd_{0.78}Pr_{0.22})_{14.7}(Fe_{0.9}Co_{0.1})_{78.85}B_{5.8}Cu_{0.15}Al_{0.2}Ga_{0.3} |
| Example 2 | | |
| Comparative | Nd_{11.3}Pr_{2.6}Fe_{bal}Co_{15.9}B_{5.8}Cu_{0.15}Al_{0.2}Ga_{0.3} | (Nd_{0.81}Pr_{0.19})_{13.9}(Fe_{0.9}Co_{0.2})_{79.65}B_{5.8}Cu_{0.15}Al_{0.2}Ga_{0.3} |
| Example 3 | | |
| Comparative | Nd_{11.3}Pr_{2.6}Fe_{bal}Co_{23.9}B_{5.8}Cu_{0.15}Al_{0.2}Ga_{0.3} | (Nd_{0.81}Pr_{0.19})_{13.9}(Fe_{0.9}Co_{0.3})_{79.65}B_{5.8}Cu_{0.15}Al_{0.2}Ga_{0.3} |
| Example 4 | | |
| Example 1 | Nd_{10.9}La_{0.6}7Pr_{2.5}Fe_{bal}Co_{7.9}B_{5.7}Cu_{0.15}Al_{0.2}Ga_{0.3} | (Nd_{0.77}Pr_{0.18}La_{0.05})_{14.07}(Fe_{0.9}Co_{0.1})_{79.58}B_{5.7}Cu_{0.15}Al_{0.2}Ga_{0.3} |
| Example 2 | Nd_{11.1}La_{0.7}Pr_{2.6}Fe_{bal}Co₁₆B_{5.7}Cu_{0.15}Al_{0.2}Ga_{0.3} | (Nd_{0.77}Pr_{0.18}La_{0.05})_{14.4}(Fe_{0.9}Co_{0.2})_{79.25}B_{5.7}Cu_{0.15}Al_{0.2}Ga_{0.3} |
| Example 3 | Nd₁₁La_{0.7}Pr_{2.5}Fe_{bal}Co_{23.8}B_{5.8}Cu_{0.15}Al_{0.2}Ga_{0.3} | (Nd_{0.77}Pr_{0.18}La_{0.05})_{14.2}(Fe_{0.9}Co_{0.3})_{79.35}B_{5.8}Cu_{0.15}Al_{0.2}Ga_{0.3} |
| Example 4 | Nd_{10.4}La_{1.3}Pr_{2.3}Fe_{bal}Co_{7.9}B_{5.7}Cu_{0.15}Al_{0.2}Ga_{0.3} | (Nd_{0.73}Pr_{0.17}La_{0.1})₁₄(Fe_{0.9}Co_{0.1})_{79.65}B_{5.7}Cu_{0.15}Al_{0.2}Ga_{0.3} |

| | | | Specific Heat Treatment | | |
|---|---|---|---|---|---|
| | Composition of Rare Earth Magnet | | First | | Second |
| | La | Co | Holding | Cooling | Holding |
| | molar | molar | Temperature | Rate | Temperature |
| | ratio | ratio | (° C.) | (° C./min) | (° C.) |
| Comparative | 0 | 0.01 | 950 | 1.0 | 650 |
| Example 1 | | | | | |
| Comparative | 0 | 0.10 | 950 | 1.0 | 600 |
| Example 2 | | | | | |
| Comparative | 0 | 0.20 | 950 | 1.0 | 550 |
| Example 3 | | | | | |
| Comparative | 0 | 0.30 | 950 | 1.0 | 550 |
| Example 4 | | | | | |
| Example 1 | 0.05 | 0.10 | 950 | 1.0 | 600 |
| Example 2 | 0.05 | 0.20 | 950 | 1.0 | 500 |
| Example 3 | 0.05 | 0.30 | 950 | 1.0 | 500 |
| Example 4 | 0.10 | 0.10 | 950 | 1.0 | 550 |

TABLE 1-2

| | | | Grain Boundary Phase | | | | | | | |
|---|---|---|---|---|---|---|---|---|---|---|
| | | | | | Volume | | | | | |
| | | | | Volume | Ratio of | | | Magnetic Properties (300 K) | | |
| | Main Phase | | | Fraction of | 1-2 Phase | | | | Magnetic | |
| | Average | | Volume | Phase | in Grain | | | | Field at 5% | |
| | Particle | Volume | Fraction of | Other Than | Boundary | Microstructural | | | Demagnetization | |
| | Diameter | Fraction | 1-2 Phase | 1-2 Phase | Phase | Parameter | | Coercivity | Hr | |
| | (μm) | (vol %) | (vol %) | (vol %) | (—) | α | Neff | Hc (kA/m) | (kA/m) | Hr/Hc |
| Comparative | 7.0 | 93.7 | 0.3 | 6.0 | 0.05 | 0.33 | 0.95 | 811.7 | 644.6 | 0.79 |
| Example 1 | | | | | | | | | | |
| Comparative | 6.9 | 93.4 | 4.2 | 2.4 | 0.64 | 0.36 | 1.07 | 716.2 | 159.2 | 0.22 |
| Example 2 | | | | | | | | | | |
| Comparative | 6.5 | 93.3 | 5.0 | 1.7 | 0.74 | 0.39 | 1.23 | 573.0 | 95.5 | 0.17 |
| Example 3 | | | | | | | | | | |
| Comparative | 6.6 | 93.2 | 6.8 | 0.0 | 1.00 | 0.38 | 1.02 | 557.0 | 55.7 | 0.10 |
| Example 4 | | | | | | | | | | |
| Example 1 | 6.5 | 93.7 | 0.9 | 5.4 | 0.15 | 0.37 | 1.00 | 660.5 | 397.9 | 0.60 |
| Example 2 | 5.9 | 93.6 | 3.3 | 3.1 | 0.52 | 0.46 | 1.09 | 700.3 | 573.0 | 0.82 |
| Example 3 | 6.2 | 92.9 | 3.8 | 3.3 | 0.54 | 0.38 | 0.99 | 676.4 | 533.2 | 0.79 |
| Example 4 | 6.1 | 93.4 | 1.3 | 5.3 | 0.20 | 0.39 | 1.03 | 628.7 | 549.1 | 0.87 |

| | | Magnetic Properties (453 K) | | | | |
|---|---|---|---|---|---|---|
| | Magnetic Properties | | Magnetic | | | Temperature |
| | (300 K) | | Field at 5% | | | Coefficient of |
| | Residual | Coercivity | Demagnetization | | Residual | Residual |
| | Magnetization | Hc | Hr | | Magnetization | Magnetization |
| | (T) | (kA/m) | (kA/m) | Hr/Hc | (T) | (%/K) |
| Comparative | 1.43 | 191.0 | 151.2 | 0.79 | 1.13 | −0.14 |
| Example 1 | | | | | | |
| Comparative | 1.39 | 175.1 | 39.8 | 0.23 | 1.14 | −0.12 |
| Example 2 | | | | | | |
| Comparative | 1.38 | 175.1 | 31.8 | 0.18 | 1.17 | −0.10 |
| Example 3 | | | | | | |
| Comparative | 1.37 | 167.1 | 23.9 | 0.14 | 1.15 | −0.10 |
| Example 4 | | | | | | |
| Example 1 | 1.40 | 198.9 | 143.2 | 0.72 | 1.18 | −0.10 |
| Example 2 | 1.39 | 198.9 | 159.2 | 0.80 | 1.21 | −0.08 |
| Example 3 | 1.38 | 167.1 | 127.3 | 0.76 | 1.19 | −0.09 |
| Example 4 | 1.38 | 183.0 | 151.2 | 0.83 | 1.17 | −0.10 |

Note:
The 1-2 phase means a phase having an RFe₂-type crystal structure.

TABLE 2-1

| | Composition of Rare Earth Magnet | | | |
|---|---|---|---|---|
| | | | La | Co |
| | Representation 1 | Representation 2 | molar | molar |
| | (molar ratio) | (molar ratio) | ratio | ratio |
| Comparative | Nd_{11.3}Pr_{2.6}Fe_{bal}Co_{0.8}B_{5.9}Cu_{0.15}Al_{0.2}Ga_{0.3} | (Nd_{0.81}Pr_{0.19})_{13.9}(Fe_{0.99}Co_{0.01})_{79.55}B_{5.9}Cu_{0.15}Al_{0.2}Ga_{0.3} | 0 | 0.01 |
| Example 5 | | | | |
| Comparative | Nd_{11.5}Pr_{2.7}Fe_{bal}Co_{7.8}B_{5.8}Cu_{0.15}Al_{0.2}Ga_{0.3} | (Nd_{0.78}Pr_{0.22})_{14.7}(Fe_{0.9}Co_{0.1})_{78.85}B_{5.8}Cu_{0.15}Al_{0.2}Ga_{0.3} | 0 | 0.10 |
| Example 6 | | | | |
| Comparative | Nd_{11.3}Pr_{2.6}Fe_{bal}Co_{15.9}B_{5.8}Cu_{0.15}Al_{0.2}Ga_{0.3} | (Nd_{0.81}Pr_{0.19})_{13.9}(Fe_{0.9}Co_{0.2})_{79.65}B_{5.8}Cu_{0.15}Al_{0.2}Ga_{0.3} | 0 | 0.20 |
| Example 7 | | | | |
| Example 5 | Nd_{10.9}La_{0.6}7Pr_{2.5}Fe_{bal}Co_{7.9}B_{5.7}Cu_{0.15}Al_{0.2}Ga_{0.3} | (Nd_{0.77}Pr_{0.18}La_{0.05})_{14.07}(Fe_{0.9}Co_{0.1})_{79.58}B_{5.7}Cu_{0.15}Al_{0.2}Ga_{0.3} | 0.05 | 0.10 |
| Example 6 | Nd_{11.1}La_{0.7}Pr_{2.6}Fe_{bal}Co₁₆B_{5.7}Cu_{0.15}Al_{0.2}Ga_{0.3} | (Nd_{0.77}Pr_{0.18}La_{0.05})_{14.4}(Fe_{0.9}Co_{0.2})_{79.25}B_{5.7}Cu_{0.15}Al_{0.2}Ga_{0.3} | 0.05 | 0.20 |

| | Diffusion Penetration-cum-Specific Heat Treatment | | | | |
|---|---|---|---|---|---|
| | | Amount | Diffusion and | | |
| | | Diffused and | Penetration | | Second |
| | Composition of | Penetrated t | (First Holding) | Cooling | Holding |
| | Modifier | (parts by | Temperature | Rate | Temperature |
| | (molar ratio) | mol) | (° C.) | (° C./min) | (° C.) |
| Comparative | Tb_{0.82}Cu_{0.18} | 1.4 | 950 | 1.0 | 650 |
| Example 5 | | | | | |
| Comparative | Tb_{0.82}Cu_{0.18} | 1.4 | 950 | 1.0 | 600 |
| Example 6 | | | | | |
| Comparative | Tb_{0.82}Cu_{0.18} | 1.4 | 950 | 1.0 | 550 |
| Example 7 | | | | | |
| Example 5 | Tb_{0.82}Cu_{0.18} | 1.4 | 950 | 1.0 | 600 |
| Example 6 | Tb_{0.82}Cu_{0.18} | 1.4 | 950 | 1.0 | 500 |

TABLE 2-2

| | | | Grain Boundary Phase | | | | | | | |
|---|---|---|---|---|---|---|---|---|---|---|
| | | | | | Volume | | | | | |
| | | | | Volume | Ratio of | | | | | |
| | Main Phase | | | Fraction of | 1-2 Phase | | | Magnetic Properties (300 K) | | |
| | Average | | Volume | Phase | in Grain | | | | Magnetic | |
| | Particle | Volume | Fraction of | Other Than | Boundary | Microstructural | | Coercivity | Field at 5% | |
| | Diameter | Fraction | 1-2 Phase | 1-2 Phase | Phase | Parameter | | Hc | Demagnetization | |
| | (μm) | (vol %) | (vol %) | (vol %) | (—) | α | Neff | (kA/m) | Hr (kA/m) | Hr/Hc |
| Comparative | 7.0 | 93.7 | 0.3 | 6.0 | 0.05 | 0.42 | 0.82 | 1655.2 | 1034.5 | 0.63 |
| Example 5 | | | | | | | | | | |
| Comparative | 6.9 | 93.4 | 4.2 | 2.4 | 0.64 | 0.56 | 0.96 | 1607.5 | 756.0 | 0.47 |
| Example 6 | | | | | | | | | | |
| Comparative | 6.5 | 93.3 | 5.0 | 1.7 | 0.74 | 0.45 | 1.01 | 1336.9 | 119.4 | 0.09 |
| Example 7 | | | | | | | | | | |
| Example 5 | 6.5 | 93.7 | 0.9 | 5.4 | 0.15 | 0.61 | 1.22 | 1456.3 | 756.0 | 0.52 |
| Example 6 | 5.9 | 93.6 | 3.3 | 3.1 | 0.52 | 0.49 | 1.21 | 1336.9 | 676.4 | 0.51 |

| | | Magnetic Properties (453 K) | | | | |
|---|---|---|---|---|---|---|
| | Magnetic Properties | | Magnetic | | | Temperature |
| | (300 K) | | Field at 5% | | | Coefficient of |
| | Residual | Coercivity | Demagnetization | | Residual | Residual |
| | Magnetization | Hc | Hr | | Magnetization | Magnetization |
| | (T) | (kA/m) | (kA/m) | Hr/Hc | (T) | (%/K) |
| Comparative | 1.33 | 382.0 | 254.6 | 0.67 | 1.08 | −0.12 |
| Example 5 | | | | | | |
| Comparative | 1.31 | 302.4 | 143.2 | 0.47 | 1.12 | −0.09 |
| Example 6 | | | | | | |
| Comparative | 1.27 | 278.5 | 31.8 | 0.11 | 1.14 | −0.07 |
| Example 7 | | | | | | |
| Example 5 | 1.33 | 358.1 | 198.9 | 0.56 | 1.15 | −0.09 |
| Example 6 | 1.31 | 397.9 | 214.9 | 0.54 | 1.17 | −0.07 |

Note:
The 1-2 phase means a phase having an RFe₂-type crystal structure.

From Table 1-1, Table 1-2, FIG. 3 and FIG. 4, it could be confirmed that in the samples of Examples 1 to 4, both the squareness and the residual magnetization at high temperatures are excellent. On the other hand, it could be confirmed that in the samples of Comparative Examples 1 to 4, both or either one of the squareness and the residual magnetization at high temperatures is poor. From Table 2-1 and Table 2-2, it could also be confirmed that in the samples of Examples 5 and 6 and Comparative Examples 5 to 7, where a modifier is diffused and penetrated, the same results as in the samples of Examples 1 to 4 and Comparative Examples 1 to 4, where a modifier is not diffused and penetrated, are obtained.

From FIG. 5A, FIG. 5B and FIG. 5C, it could be confirmed that in the sample of Example 2, the content of a phase having an RFe₂-type crystal structure is very small. In addition, in FIG. 5C, the composition of the grain boundary phase is represented by (Nd_{0.93}La_{0.7})_{4.3}Fe, and it was acknowledged that the molar ratio (0.7) of La in the grain boundary is greater than the molar ratio (0.05) of La in the overall composition of Example 2. From this, it could be confirmed that La is likely present in the grain boundary phase and in turn, tends to contribute to the suppression of generation of a phase having an RFe₂-type crystal structure. On the other hand, from FIG. 6A, FIG. 6B and FIG. 6C, it could be confirmed that in the sample of Comparative Example 3, the content of a phase having an RFe₂-type crystal structure is relatively large. Also, it could be confirmed that a phase having an RFe₂-type crystal structure is present in a large amount in the part corresponding to the adjacent part 22 illustrated in FIG. 8B.

FIG. 7 is a TEM image taken in microstructure observation of a vicinity of the contact surface between the main phase and the grain boundary phase regarding the sample of Example 2. An electron beam was made incident on (001) plane relative to the main phase particle in the upper left of FIG. 7, and the microstructure of the particle was observed. As denoted by dashed lines of FIG. 7, low-index planes (001), (110), and (111) are present as facet interfaces in the outer periphery of the main phase. It could be understood from this that the contact surface between the main phase and the grain boundary phase is a facet interface.

From these results, the effects of the rare earth magnet of the present disclosure and the production method thereof could be verified.

### REFERENCE SIGNS LIST

10 Main phase
15 Contact surface
20 Grain boundary phase
22 Adjacent part
24 Triple point
26 Phase having an RFe₂-type crystal structure
70 Cooling apparatus
71 Melting furnace
72 Molten alloy
73 Tundish
74 Cooling roll
75 Magnetic alloy
100 Rare earth magnet of the present disclosure
200 Conventional rare earth magnet

1. A rare earth magnet comprising a main phase and a grain boundary phase present around the main phase,
wherein the overall composition is represented, in terms of molar ratio, by the formula: (R¹₍₁₋ₓ₎Laₓ)_{y}(Fe_{(1-z)}Co_{z})_{(100-y-w-v)}B_{w}M¹ᵥ, wherein R¹ is one or more elements selected from the group consisting of Nd, Pr, Gd, Tb, Dy, and Ho, and M¹ is one or more elements selected from the group consisting of Ga, Al, Cu, Au, Ag, Zn, In, and Mn, and unavoidable impurity elements, and wherein
0.02≤x≤50.1,
12.0≤y≤20.0,
0.1≤z≤50.3,
5.0≤w≤20.0, and
0≤v≤2.0,
the main phase has an R₂Fe₁₄B-type crystal structure, wherein R is one or more rare earth elements,
the average particle diameter of the main phase is from 1 to 10 μm, and
the volume ratio of a phase having an RFe₂-type crystal structure in the grain boundary phase is 0.60 or less relative to the grain boundary phase.

2. A rare earth magnet comprising a main phase and a grain boundary phase present around the main phase,
wherein the overall composition is represented, in terms of molar ratio, by the formula: (R¹₍₁₋ₓ₎Laₓ)_{y}(Fe_{(1-z)}Co_{z})_{(100-y-w-v)}B_{w}M¹ᵥ.(R²₍₁₋ₛ₎M²ₛ)ₜ, wherein each of R¹ and R² is one or more elements selected from the group consisting of Nd, Pr, Gd, Tb, Dy, and Ho, M is one or more elements selected from the group consisting of Ga, Al, Cu, Au, Ag, Zn, In, and Mn, and unavoidable impurity elements, and M² is one or more metal elements, which are alloyed with R², other than rare earth elements, and unavoidable impurity elements, and wherein
0.02≤x≤50.1,
12.0≤y≤20.0,
0.1≤z≤50.3,
5.0≤w≤20.0,
0≤v≤2.0,
0.05≤s≤0.40, and
0.1≤t≤10.0,
the main phase has an R₂Fe₁₄B-type crystal structure, wherein R is one or more rare earth elements,
the average particle diameter of the main phase is from 1 to 10 μm, and
the volume ratio of a phase having an RFe₂-type crystal structure in the grain boundary phase is 0.60 or less relative to the grain boundary phase.

3. The rare earth magnet according to claim 2, wherein t satisfies 0.5≤t≤2.0.

4. The rare earth magnet according to claim 2, wherein R² is Tb and M² is Cu and unavoidable impurity elements.

5. The rare earth magnet according to claim 1, wherein the microstructural parameter α represented by the formula: H_{c}=α·Hₐ−N_{eff}·Mₛ, wherein H_{c} is the coercivity, Hₐ is the anisotropic magnetic field, Mₛ is the saturation magnetization, and N_{eff} is the self-demagnetizing field coefficient, is from 0.30 to 0.70.

6. The rare earth magnet according to claim 1, wherein R¹ is one or more elements selected from the group consisting of Nd and Pr and M¹ is one or more elements selected from Ga, Al and Cu, and unavoidable impurity elements.

7. A method for producing the rare earth magnet according to claim 1, comprising:
preparing a molten alloy having a composition represented, in terms of molar ratio, by the formula: (R¹₍₁₋ₓ₎Laₓ)_{y}(Fe_{(1-z)}Co_{z})_{(100-y-w-v)}B_{w}M¹ᵥ, wherein R¹ is one or more elements selected from the group consisting of Nd, Pr, Gd, Tb, Dy, and Ho, and M¹ is one or more elements selected from the group consisting of Ga, Al, Cu, Au, Ag, Zn, In, and Mn, and unavoidable impurity elements, and wherein
0.02≤x≤50.1,
12.0≤y≤20.0,
0.1≤z≤50.3,
5.0≤w≤20.0, and
0≤v≤2.0,
cooling the molten alloy at a rate of 1 to 10⁴° C./sec to obtain a magnetic ribbon or a thin magnetic strip,
pulverizing the magnetic ribbon or the thin magnetic strip to obtain a magnetic powder, and
sintering the magnetic powder at 900 to 1,100° C. to obtain a sintered body.

8. The production method of a rare earth magnet according to claim 7, wherein the sintered body is held at 850 to 1,000° C. over 50 to 300 minutes and then cooled to 450 to 700° C. at a rate of 0.1 to 5.0° C./min.

9. The production method of a rare earth magnet according to claim 7, further comprising:
preparing a modifier having a composition represented, in terms of molar ratio, by the formula: R²₍₁₋ₛ₎M²ₛ, wherein R² is one or more elements selected from the group consisting of Nd, Pr, Gd, Tb, Dy, and Ho, and M² is one or more metal elements, which are alloyed with R² other than rare earth elements, and unavoidable impurity elements, and wherein 0.05≤s≤0.40, and
diffusing and penetrating the modifier into the sintered body.

10. The production method of a rare earth magnet according to claim 9, wherein the modifier is brought into contact with the sintered body to obtain a contact body and the contact body is heated at 900 to 1,000° C., held at 900 to 1,000° C. over 50 to 300 minutes and then cooled to 450 to 700° C. at a rate of 0.1 to 5.0° C./min to diffuse and penetrate the modifier into the sintered body.

11. The production method of a rare earth magnet according to claim 9, wherein the sintered body is held at 850 to 1,000° C. over 50 to 300 minutes at least either before or after the diffusion and penetration of the modifier and then cooled to 450 to 700° C. at a rate of 0.1 to 5.0° C./min.

12. The production method of a rare earth magnet according to claim 7, comprising:
preparing a modifier powder having a composition represented, in terms of molar ratio, by the formula: R²₍₁₋ₛ₎M²ₛ, wherein R² is one or more elements selected from the group consisting of Nd, Pr, Gd, Tb, Dy, and Ho, and M² is metal elements, which are alloyed with R² other than rare earth elements, and unavoidable impurity elements, and wherein 0.05≤s≤0.40,
mixing the magnetic powder and the modifier powder to obtain a mixed powder, and
sintering the mixed powder at 900 to 1,100° C. to obtain a sintered body.

13. The production method of a rare earth magnet according to claim 12, wherein the sintered body obtained by sintering the mixed powder is held at 850 to 1,000° C. over 50 to 300 minutes and then cooled to 450 to 700° C. at a rate of 0.1 to 5.0° C./min.

14. The production method of a rare earth magnet according to claim 9, wherein R² is Tb and M² is Cu and unavoidable impurity elements.

15. The production method of a rare earth magnet according to claim 7, wherein R is one or more elements selected from the group consisting of Nd and Pr and M is one or more elements selected from Ga, Al and Cu, and unavoidable impurity elements.
